(19) United States
(12) Patent Application Publication
(10) Pub. No.: US 2017/0103160 A1
(43) Pub. Date: Apr. 13, 2017

(54) Customer Comfort Optimization Method, Apparatus, and System

(71) Applicant: Milsco Manufacturing Company, A Unit of Jason Incorporated, Milwaukee, WI (US)

(72) Inventor: Michael Hynes, Burlington, WI (US)

(21) Appl. No.: 15/292,096

(22) Filed: Oct. 12, 2016

Related U.S. Application Data
(60) Provisional application No. 62/240,505, filed on Oct. 12, 2015.

(51) Int. Cl. G06F 17/50; G06T 17/00

(52) U.S. Cl. CPC G06F 17/5095; G06T 17/00; G06F 3/04815

(57) ABSTRACT

A method, apparatus and system for enabling a person, preferably a prospective purchaser, to virtually try out a consumer good that preferably is motorcycle using anthropometric data of the person to fit a virtual model of the person to a virtual model of the motorcycle and using aspects analyzed relating to the posture of the virtual person fitted to the virtual motorcycle to obtain a predictive estimate of comfort that can be communicated, e.g., displayed, to the person to evaluate whether a particular one of a plurality of different motorcycles, motorcycle configurations, and/or motorcycle accessory configurations would be more comfortable that one or more other motorcycles, motorcycle configurations, and/or motorcycle accessory configurations. A preferred method is implemented with a processor-equipped linked to a display, which can be configured as a kiosk for retail use, which can include an anthropometric data input, preferably a biometric scanner, from which at least one, preferably at least a plurality, more preferably at least a plurality of pairs, i.e., at least three, types of anthropometric data are obtain used to create the virtual model of the person that is fitted, preferably posture fitted, to a virtual model of the motorcycle.

### CROSS REFERENCE

This application claims priority in U.S. Provisional Patent Application No. 62/240,505, filed Oct. 12, 2015, under 35 U.S.C. §119(e), the entirety of which is incorporated by reference herein.

### FIELD

The present invention is directed to a method, apparatus and/or system for helping a prospective or actual purchaser in purchasing or evaluating purchase of a consumer good, preferably a vehicle, more preferably a motorcycle, based on at least in part anthropometric data of the purchaser, and more particularly, to a method, apparatus and/or system that uses anthropometric data of the purchaser in facilitating evaluation of the good, preferably vehicle, more preferably motorcycle, and customization thereof in a manner that helps optimize fit, comfort and/or ergonomics by optimizing the purchaser's posture.

### BACKGROUND

Currently a person considering the purchase of almost any type of vehicle is faced with a try it before you buy it approach as they typically end up trying several different vehicles and/or even several different variants or configurations of a particular vehicle before trying to reach a final decision. Many times there are features, accessories, customizable components and/or even after-market add-ons the purchaser is interested in evaluating to add to their desired vehicle but have no way of knowing whether they will find them desirable until after they actually receive their vehicle equipped with the purchaser's customizations and try out the purchaser-customized vehicle. Where any of these features, accessories, custom components, and/or after-market add-ons end up being unsatisfactory to the purchaser, it frequently ends up costing the purchaser money to remove and replace that which is unsatisfactory with something else. Just as bad, if not worse, is the case where the purchaser decided not to add one or more features, accessories, custom components, and/or after-market add-ons and ends up being less than satisfied with their purchased vehicle when their satisfaction could have and likely would have been greater had one or more of such user-contemplated features, accessories, custom components, and/or after-market add-ons being included in their vehicle build. Since it is presently virtually impossible to predict how purchaser-desired customizations will turn out before an actual real world vehicle with the purchaser's customizations is tried out by the purchaser, this trial and error method of present day vehicle purchasing often continues long after vehicle purchase taking up even more time, effort and money by purchaser in trying to make their vehicle into what they had hoped it would be when they first went to purchase it.

While some purchasers might initially enjoy the post-purchase tweaking of their vehicle frequently needed to customize their vehicle more to their desire, the enjoyment can end up being replaced with frustration and even anger should they reach the point where they believe their vehicle can never be customized to their liking. For those who spend money after the purchase unsuccessfully trying but never being able to customize the vehicle they desired and for those who expected their as-purchased vehicle to have been more to their liking when it arrived, considerable goodwill can be lost for these unsatisfied purchasers leading them to purchase a different make of vehicle next time around.

There are certain types of vehicles where considerable attempts have been made in the past to enable an actual or prospective purchaser to customize certain features, accessories, components and/or the like to not only give the purchaser the ability to individualize the vehicle to their liking but also to provide choices that enable comfort to be increased as comfort is typically important to the purchaser. These types of vehicles which purchasers tend to customize during and after purchase include not only automotive and off-road vehicle but also include tandem-wheeled and/or side-by-side vehicles, wheeled vehicles equipped with two and three wheels, e.g., 2 and/or 3 wheeled cycles, such as bikes, bicycles, trikes, tricycles, motorbikes and motorcycles. As discussed in more detail below, while actual and prospective bike purchasers frequently wish to not only determine which one of two or more different bike makes, bike models or other variations of bikes under consideration to buy, they also then typically wish customize or individualize their final choice or choices to make it more to their liking and/or comfort. Since such purchasers will nearly always spend long hours riding the bike they purchase, many of the customizations considered in making their final purchase decision are focused on comfort.

This is especially true for those wishing to purchase motorcycles. Given the relatively large amount of money typically spent along with myriad customization choices provided by many motorcycle manufacturers, retailers, OEMs, third-parties and the like, expectations have never been higher for prospective purchasers believing they should be able to customize whatever make and model of motorcycle they select into something that truly is their own and which also is a treat to ride in terms of luxury and comfort. While the ever-increasing number of user-selectable and user-customizable options make it easier than ever for a purchaser to custom-build a bike that is as individual as they are, it still is virtually impossible for the purchaser to actually know whether all of the choices and customizations they made or wish to make will result in a bike that is actually comfortable to ride. While many purchasers are accepting of the need to spend additional money on their bike after they have purchased it in order to undo certain customizations, remove certain components, and/or replace components and/or customizations with others, those that are not so accepting can end up becoming unsatisfied purchasers. The same can happen to those who are initially accepting but which reach the conclusion they made the wrong choice where even post-purchase changes to the purchased bike fail to remedy its shortcomings.

Present day prospective purchasers and actual motorcycle owners seeking to ergonomically customize a motorcycle for their body type still face a try it before you buy it approach. Dealerships, bike repair shops, and bike customization companies typically offer numerous options for handle bars, seats, backrests, pegs or boards, and suspensions, e.g., suspensions with different travel or adjustable to provide different travel/travel ranges, to try to help enhance a motorcycle owner or operator's experience usually most often by trying to help them achieve a better or more optimal riding or driving posture which typically translates into increased or improved comfort. Not infrequently, the process involves sifting through one or more catalogs, some almost a thousand pages in length, to try to come up with the right combination of one or more handle bars, seats, backrests, pegs, boards, sissy bars, pillions, and/or suspensions (and/or suspension settings and/or options) that will provide better operator posture and hence improved comfort when mounted to the motorcycle.

While some establishments will have a fit shop on site enabling the purchaser or owner to try out one or more such combinations on a platform mule to try to get a feel for how they affect overall posture, fit and comfort before actually buying them, a considerable amount of trial and error is still involved. Even then, particularly where there are differences between the platform mule and the actual motorcycle, it is not uncommon for a combination which seemed promising on the mule to deliver different results when used on the actual motorcycle. Even where the establishment and purchaser/owner believe they have come up with an optimal combination, it is not just possible but perhaps even likely there may be one or more even more optimal combinations available that were never considered due to the hit-and-miss trial-and-error methodology used today.

While manufacturers of these components and motorcycle manufacturers use 3D modeling tools, e.g., software, such as Creo Manikin, during product development to try to predict posture and system ergonomics, operator modeling used to predict posture is typically only done at the 35%, 50% and 85% percentiles. Unfortunately, not only are these models relatively limited in their applicability to real world situations where many purchasers and owners either lie outside these percentiles or appear to fall within these percentiles but in reality deviate anthropomorphically in some manner not accounted for by the models. Perhaps not surprisingly, they have not proven to be very useful in accurately predicting posture nor in determining comfort levels that correlate with the predicted posture. As a result, present day predictive posture models are poorly suited for optimizing best case posture and comfort as they do not take into account the impact of the actual size and shape of each specific purchaser and owner as it relates to such available combinations of options including handle bar, seat, backrest, peg, board, and suspension options and combinations thereof. That is why in today's retail environment, the purchaser is basically left to guess whether relative crude 2-D images, such as those provided using a rather simple motorcycle ergonomics simulator like http://cycle-ergo.com/whether a proposed customization or two might or might not work.

What is needed is a new way of evaluating purchasing of a product, preferably a vehicle, more preferably a motorcycle, in a manner that optimizes the ergonomics and fit thereof based on and/or using anthropomorphic data of the purchaser or end user particularly for optimizing the posture and/or comfort of the purchaser or end user.

### SUMMARY

The present invention is directed to a method, apparatus and system that empowers prospective and actual purchasers as well as actual owners by enabling them to evaluate such options using anthropometric information of the purchaser or owner in providing options or combinations thereof best suited for that purchaser or owner based on predicted posture and/or comfort using their specific anthropometric information that significantly improves their chances of buying a motorcycle customized to their liking puts them in a comfortable riding position thereby improving purchaser satisfaction. Such an invention is well suited for use by prospective and actual purchasers in a method of evaluating at least a plurality of pairs, i.e., at least three, of makes and/or models of motorcycles using anthropometric characteristics, data and/or measurements of the purchaser of the present invention to provide the purchaser with a subset thereof of one or more motorcycles whose predicted posture and comfort are more optimal than the rest. Such an invention is also well suited for use by prospective and actual purchasers in a further implementation of a method of evaluating at least a plurality of pairs, i.e., at least three, of options relating to characteristics, features, components, and/or the like, including at least a plurality of pairs of handlebar, seat, backrest, peg, board, and suspension options and combinations thereof, and providing the purchaser with a subset thereof of one or more such options or combination of options whose predicted posture and comfort when used with a particular make and model of motorcycle are more optimal than the rest.

The result is a method, apparatus and system of the present invention that advantageously empowers actual and prospective motorcycle purchasers to be able to still choose what they want in customizing their motorcycle leading to higher purchaser satisfaction, reduced after-purchase costs, and decreased returns and perhaps even lessened warranty claims. Such a method, apparatus and system of the present invention does so by using anthropometric information of the purchaser to determine a subset of component, feature, layout and setup options from a larger set of component, feature, layout and setup options whose predictive posture and comfort level is not only higher but correlates well with actual posture and comfort level for the purchaser when the purchaser receives and uses their optimal-fit comfort-enhanced motorcycle build.

A preferred implementation of a method, apparatus and/or system of the present invention applies anthropometric information of the actual purchaser to a virtual and/or three-dimensional (3D or 3-D) model of the bike selected by the purchaser together with a virtual and/or three-dimensional (3D or 3-D) model of the purchaser to determine which subset of the larger set of component, feature, layout and setup options for that bike will produce an anthropometrically modeled purchaser on the modeled bike that produces a predictive posture having a minimum desired predictive posture, a minimum desired predictive posture level, a minimum desired predictive posture threshold, or which falls within a desired predictive posture range. In one preferred implementation of a method, apparatus and/or system of the present invention, anthropometric information of the purchaser is used to model the purchaser and selected bike to determine which subset of one or more component, feature, layout and setup options modeled with the modeled selected bike put the purchaser anthropometrically modeled on the bike in such a predictive posture that also has a desired minimum predicted or actual/known correlated comfort level, meeting a desired minimum predicted or actual/known correlated comfort threshold, and/or which falls within a desired predicted or actual/known comfort level range.

In one such preferred implementation of a method, apparatus and/or system of the present invention, a database of bikes or motorcycles which a purchaser can select is generated or built that preferably includes its virtual or three-dimensional model and/or data from which its virtual or three-dimensional model can be generated. In a preferred implementation, each model and/or data used to generate each model can be and preferably is done in a manner permitting not only fitting and posturing of an anthropometrically modeled purchaser thereon but also modeling and fitting thereto of each component, feature, layout and/or setup option in a master set or database containing all available components, features, layouts and/or setups from which the purchaser can select or otherwise consider during virtual customization. In one such preferred implementation, each bike or motorcycle in such a database can be and preferably is three dimensionally modeled as a platform mule or three dimensionally modeled like a platform mule presently used in fitting shops with each such three dimensionally modeled bike or motorcycle platform mule set up so a three dimensionally modeled handlebar(s), seat(s), peg(s)/board(s), sissy bar(s), pillion(s), backrest(s), suspension(s), and other available component options selected by the purchaser in carrying out virtual customization can be virtually mounted to the selected three dimensionally modeled bike or motorcycle platform mule during virtual customization by the purchaser.

In one such preferred implementation, a purchaser selects at least one component, feature, layout and setup option from a database containing at least a plurality of pairs, i.e., at least three, of virtually modeled component, feature, layout and setup options. If desired, the purchaser can select more than one component, feature, layout and setup option from the database. When the purchaser is finished with this virtual customization selection step, a processor equipped device, such as a computer, e.g., personal computer, desktop computer, mainframe, or other device equipped with a microprocessor, microcontroller or the like, takes each one of the component, feature, layout and setup options selected by the purchaser and virtually mounts and/or virtually modifies the three dimensionally modeled bike or motorcycle platform mule to virtually create, e.g. virtualize, a virtual three-dimensional model of the bike or motorcycle virtually custom modified in the manner desired by the purchaser before virtually fitting the purchaser thereto or thereon using anthropometric data of the purchaser.

In such a preferred implementation, a fitting algorithm implemented in software and/or firmware is executed by the processor equipped device to fit a virtual three dimensionally modeled anthropometric purchaser(s) or end user(s) on the virtually customized three-dimensional bike or motorcycle and a posture determination is made based on such a virtual fitting. In one such preferred fitting algorithm, the anthropometrically three-dimensional virtual model of the purchaser is postured during fitting in one of at least a plurality of pairs, i.e. a, at least three, of postures or posture deviations based on a known locator, e.g., SIP, or the like, of the virtually customized bike or motorcycle in determining a predictive posture or predictive posture range. If desired, and in a preferred implementation, a predicted comfort level or predicted comfort level range determination can also be made independently of and/or based upon the predictive posture and/or predictive posture range determined in carrying out such a fitting algorithm. The determined predictive posture or predictive posture range and/or the predicted comfort level and/or predicted comfort level range are preferably stored for later use in a comparison step where the predictive posture or predictive posture range and/or the predicted comfort level and/or predicted comfort level range determined for each virtual fitting, e.g., determined for each component, feature, layout and/or setup of each virtual customization selected by the purchaser and/or for each combination/permutation thereof, is compared in a comparison step or algorithm implemented in software and/or firmware to determine which one or more of the virtual customizations selected by the purchaser have a predictive posture or predictive posture range and/or the predicted comfort level and/or predicted comfort level range meeting a desired minimum or threshold or falling within a predetermined desired range.

When virtual customization analysis in accordance with carrying out a preferred implementation of a method, apparatus, and system of the present invention is completed, the purchaser is presented with only those posture or comfort level approved virtual customizations having at least one of (a) a desired minimum predictive posture, (b) a desired minimum predictive posture value, (c) a predictive posture greater than a desired threshold, (d) a predictive posture falling within a desired range, (e) a desired minimum predicted comfort level, (f) a desired minimum predicted comfort level value, (g) a predicted comfort level greater than a desired threshold, and/or (h) a predicted comfort level falling within a desired range as determined during the comparison step. If desired, each purchaser customization meeting the aforementioned posture or comfort level approval criteria can be three dimensionally modeled and displayed on a display screen, e.g., LCD screen, touchscreen, LCD touchscreen, 3-D display, or the like, enabling the purchaser to be able to visualize in three dimensions the desired bike or motorcycle fitted with at least one posture or comfort level approved customization(s) preferably with the purchaser three dimensionally shown on their customized bike or motorcycle as an avatar (preferably an anthropometrically modeled or anthropometrically accurate human avatar having anthropometrically accurate measurements using or made from anthropometric data of the purchaser). Preferably, the purchaser can step through, selectively review, or otherwise view each approved customization to visually see each three-dimensionally modeled on such a display screen using the processor-equipped device configured in software and/or firmware with a preferred method of virtually customizing a bike or motorcycle using purchaser anthropometric data of the purchaser before making a decision as to which customization(s), set of customizations, component(s), feature(s), layout(s) and setup option(s) meeting the aforementioned approval criteria the purchaser wishes to actually implement, e.g. purchase and install or include in the bike/motorcycle build.

Where any component, feature, layout and/or setup option selected by the purchaser can be varied in angle, orientation, length, or is otherwise adjustable, such a preferred implementation preferably further includes a further algorithm, e.g., tuning or adjustment algorithm, implemented in software and/or firmware executed by a processor of the processor equipped device to vary each adjustable component, feature, layout and/or setup option, such as in a stepwise fashion, and fit the anthropometrically modeled purchaser thereto preferably by executing such a fitting algorithm for each stepwise adjustment and combination/permutation thereof. For each iteration of the fitting algorithm for each variation or adjustment setting of each adjustable component, feature, layout and/or setup option, a predictive posture and/or predictive posture range is determined using the anthropometrically modeled purchaser and stored. If desired, a predicted comfort level or predicted comfort level range can also be determined and stored.

In addition to evaluating each component, feature, layout and/or setup option and/or each combination and/or permutation thereof selected by the user during a customization selection step, a method, apparatus, and/or system of customizing using purchaser or user, e.g., operator, anthropometric data of the present invention also preferably is further configured in software and/or firmware for the processor equipped apparatus to use the purchaser/owner anthropometric data in evaluating other possible component(s), feature(s), layout(s) and/or setup(s) option(s) not selected and perhaps not even considered by the purchaser/owner to determine whether one or more such unselected or non-selected options might provide a more optimal purchaser/owner posture and/or a greater comfort level than any component, feature, layout and/or setup option selected by the purchaser/owner. In such an alternative choice determination step or algorithm implemented in software and/or firmware by the processor-equipped apparatus, the purchaser/user anthropometric data is used to determine whether a posture and/or comfort level greater than that determined for any of the purchaser/user selected options might or does exist or be available for at least a plurality of pairs, i.e., at least three, of the component(s), feature(s), layout(s) and/or setup(s) option(s) available for the bike or motorcycle being customized by the purchaser/owner which were not selected by the purchaser/owner during the purchaser/owner/user customized options selection step.

In one preferred alternative choice determination step or algorithm, each one of the component(s), feature(s), layout(s) and/or setup(s) option(s) available for the bike or motorcycle being customized by the purchaser/owner which were not selected by the purchaser/owner during the purchaser/owner/user customized options selection step is/are also evaluated during carrying out of one or more of the aforementioned fitting and/or comparison steps/algorithms to not only determine which one or more of the purchaser/owner selected customization options provide a most optimal posture and/or comfort level but also whether there are one or more options not selected by the purchaser/owner that may provide a more optimal posture and/or comfort level than any of the purchaser/owner selected options. In one such preferred alternative choice determination step or algorithm, one or more alternative customization options is automatically presented to the purchaser/owner only if execution of the aforementioned anthropometric purchaser/user model-centric customization method, apparatus and system of the present invention determines there is at least one option not selected by the purchaser/owner having a predictive posture or predicted comfort level greater than each one of the selected options made by purchaser/owner. In another such preferred alternative choice determination step or algorithm, one or more alternative customization options is automatically presented to the purchaser/owner if execution of the aforementioned anthropometric purchaser/user model-centric customization method, apparatus and system of the present invention determines there is at least one option not selected by the purchaser/owner having a predictive posture or predicted comfort level greater having an approved predictive posture or predicted comfort level as discussed in more detail above. If desired, such an alternative choice determination step or algorithm can be executed with regard to or for each component, feature, layout, and setup selected for customization optimization consideration by the purchaser/owner or can be executed with regard to each component, feature, layout and/or setup option or combination selected for customization optimization consideration by the purchaser/owner.

### DRAWING DESCRIPTION

One or more preferred exemplary embodiments of the invention are illustrated in the accompanying drawings in which like reference numerals represent like parts throughout and in which:

FIG. 1 is a perspective view of a preferred but exemplary embodiment of a bike or motorcycle purchaser/owner customization optimization apparatus, preferably in the form of a kiosk, used by the purchaser/owner to carry out a preferred method of virtual customization and virtual customization optimization of one or more components, features, layouts, and/or setups having multiple options therefore for at least at least one bike or motorcycle to be customized by the purchaser/owner;

FIG. 2 is an anthropometric data determining or obtaining device used to obtain or otherwise determine anthropometric data of the purchaser/user using the bike or motorcycle purchaser/owner customization optimization apparatus of the present invention depicted in FIG. 1;

FIG. 3 is a perspective view of another preferred kiosk with an aesthetic and/or functional design intended to mimic the appearance, function and/or operation of the product;

FIG. 4 illustrates a anthropometric data entry screen of the comfort optimization method of the present invention configured to enable manual entry of one or more pieces of anthropometric data of purchaser/owner;

FIG. 5 illustrates a screen of the comfort optimization method the invention enabling selection of one or more motorcycles for posture fitting and/or comfort evaluation by purchaser/owner, depicting a three-dimensional model or avatar of purchaser/owner of anthropometric data accurate proportions or measurements, showing such a three-dimensional model or avatar of anthropometric data modeled purchaser/owner posture fit in a riding position on at least a portion of a virtual model of a desired or selected motorcycle being comfort optimized, and illustrating a comfort prediction value calculated or otherwise obtained during virtual posture fitting of virtual model of purchaser/owner to virtual model of motorcycle;

FIG. 6 illustrates a three-dimensional model of purchaser/owner, which can be in avatar form, posture fitted to a virtual model of a motorcycle whose one or more customization options, such as one or more of handlebars, foot rests/foot pegs, and/or seats, are being comfort customized with the three-dimensional model of purchaser/owner and three-dimensional model of motorcycle rotatable, viewable from virtually any angle in a 360-degree direction, etc.

FIG. 7 is a posture analyzer result screen or window depicting effort, discomfort, joint displacement, potential energy, eye displacement, visual displacement and/or joint torque parameters obtained for virtual model of purchaser/owner from or during posture fitting in a riding position to virtual model of motorcycle which are used in determined the comfort prediction value used to determine whether a particular motorcycle and/or motorcycle configured with one or more customization options possess suitably acceptable predictive posture and/or comfort level for recommendation to purchaser;

FIG. 8 is a customization option category selection screen of the method enabling purchaser/owner to select one or more customization option categories the purchaser/owner wishes to virtually customize one or more motorcycles selected by or for purchaser/owner during a customization option comfort optimization step or steps of the present method; and

FIG. 9 is a customization option selection screen of the method enabling purchaser/owner to select at least one customization option for each one or more customization option categories previously selected by purchaser/owner in FIG. 8 for the method to comfort optimize the same by virtually mounting each selected customization option on the motorcycle selected by or for purchaser/owner and performing one or more posture fitting and/or comfort evaluation iterations of the method of the invention.

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

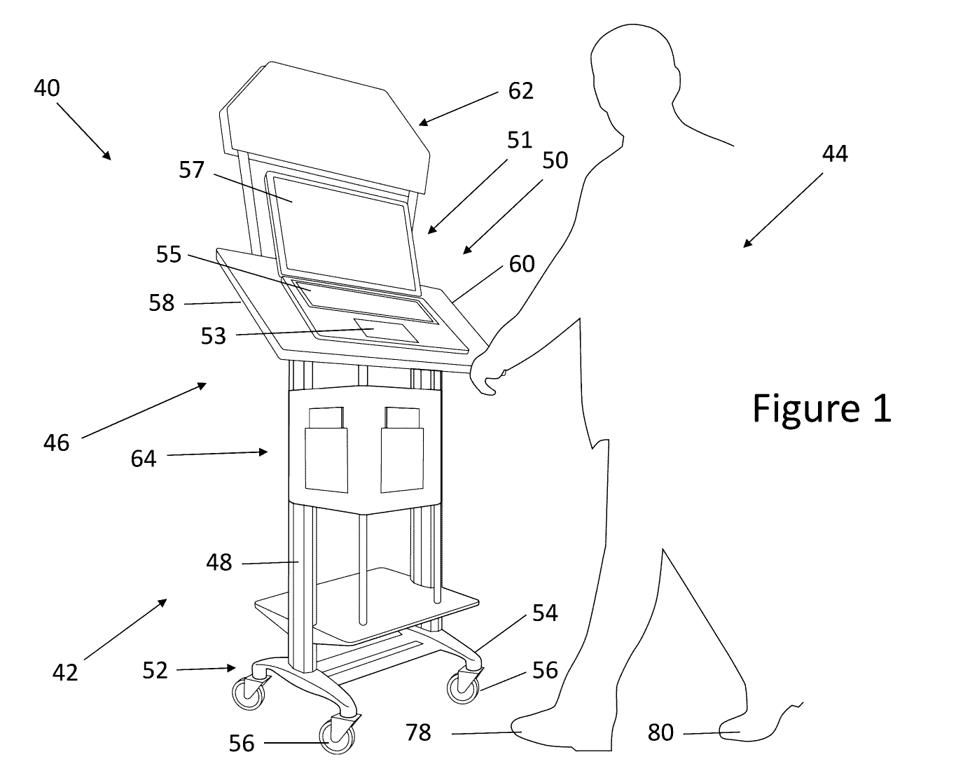

FIGS. 1-9 illustrate one or more preferred embodiments of a method, apparatus and system of the present invention for enabling an actual or prospective purchaser (or owner) of a bike or motorbike evaluate a bike or motorbike related purchase using their own anthropometric data in order to provide purchasing guidance based on their own anthropometric data that is not only specifically tailored for them but which also ensures more optimal fit, comfort and ergonomics will be achieved with regard to whatever they purchase. Such a prospective or actual purchaser anthropometric data based method, apparatus and/or system of the present invention enables modeling of the purchaser with their anthropometric data to be used with modeling of the bike or motorbike choices and/or customization options in determining whether any one or more choices and/or customization options would provide suitably optimal fit, comfort and/or ergonomics for the particular purchaser. Such a prospective or actual purchaser anthropometric data based method, apparatus and/or system of the present invention is not only configured to evaluate whether any one or more choices and/or customization options selected by the purchaser would provide suitably optimal fit, comfort and/or ergonomics but can be and preferably also is further configured to provide the purchaser with one or more choices and/or customization options not selected by the purchaser which would also provide suitably optimal fit, comfort and/or ergonomics based on the purchaser's own anthropometric data. Because such a method, apparatus and/or system of the present invention uses anthropometric data of the actual purchaser, better correlation between predictive and actual fit, comfort and/or ergonomics is advantageously achieved leading to increased purchaser satisfaction.

As discussed in more detail below, it is contemplated that at least one such purchaser anthropometric data based method, apparatus and/or system of the invention is configured for point-of-purchase deployment or use in a retail establishment that preferably is a bike or motorcycle dealership, bike or motorcycle repair shop, or the like. Where it is desired to reach prospective and actual purchasers outside of normal retail or commercial channels, it is also contemplated that such a purchaser anthropometric data based method, apparatus and/or system of the invention can be configured for use elsewhere, such as at home, via the Internet, or at a different location or environment.

FIG. 1 illustrates an exemplary but preferred embodiment of an apparatus 40, preferably in the form of a kiosk 42, having hardware and configured in software and/or firmware to carry out an anthropometric data based method of evaluating purchasing choices and/or customization options therefor using anthropometric data of a purchaser 44 using the apparatus 40 in determining whether any would meet an acceptable threshold for fit, comfort and/or ergonomics for the purchaser 44 based on their specific anthropometric data. Such a kiosk 42 can be and preferably is configured for use as a purchaser-interactive retail display 46, e.g., point-of-purchase retail display and/or purchasing implement, located in a retail establishment of the kind which sells the goods sought by purchaser 44 to be purchased and/or customized.

In a preferred embodiment, the apparatus 40 shown in FIG. 1 is a kiosk 42 having hardware and configured in software and/or firmware to carry out a purchaser anthropometric data based method of evaluating bike or motorcycle purchasing choices and/or customization options therefor using purchaser anthropometric data in determining whether any would meet an acceptable threshold for fit, comfort and/or ergonomics. In such a preferred embodiment, kiosk 42 preferably is configured for use as a purchaser-interactive retail display, e.g., point-of-purchase retail display and/or purchasing implement, in a dealership, e.g. vehicle dealership such as a motorbike or motorcycle dealership, a bike shop, e.g., bicycle shop, a repair shop, e.g., bike or motorbike repair shop, or the like. Where deployed in a dealership, kiosk 42 preferably is located on the showroom floor and can be placed in a customer-visible location nearby or adjacent one or more of the vehicles, e.g., bikes or motorbike, available for purchase that a prospective or actual purchaser might consider purchasing and/or customizing.

Kiosk 42 includes a frame 48 upon which a processor-equipped purchaser-interactive device 50 is supported, mounted or otherwise carried. Kiosk frame 48 includes a base 52 upon which the kiosk 42 is supported or otherwise can rest on a generally flat surface like a floor or the ground. Base 52 can be configured with a flat-surface supporting pedestal 54 but preferably also includes wheels or casters 56 in order to enable the kiosk 42 to be moved around as needed producing a portable/transportable kiosk 42 of the present invention.

Kiosk 42 can include a mount 58 such as in the form of a platform 60 which generally faces outwardly and generally upwardly toward purchaser 44 using the purchaser-interactive device 50 with device 50 preferably carried thereby such as in a manner that releasably or preferably substantially immovably mounts or anchors the device 50 thereto. Extending generally upwardly of the device 50 is a retail display arrangement 62 that can be and preferably is or includes a sign, display, e.g., audiovisual display, or the like containing or configurable, e.g. electronically configurable, with purchaser-perceivable indicia or the like intended to attract the attention of prospective and actual purchasers, e.g., purchaser 44, in a manner that beckons them to interact with the kiosk 42 and device 50.

With continued reference to FIG. 1, the purchaser-interactive device 50 is a processor-equipped device that has (a) at least one processor, e.g., microprocessor, microcontroller, field programmable array or the like, (b) one or more user input devices, e.g., keyboard(s), keypad(s), mouse, pointer(s), joystick(s), game controller(s), hand-held remote(s), touchscreen(s), trackpad(s), trackball(s), or the like, (c) one or more display(s), touchscreen(s), or the like, (d) memory or data storage, e.g., random access memory, read-only memory, solid state drive(s), flash drive(s), hard drive(s), or the like, along with (e) one or more other electrical components, devices, peripherals and the like. A preferred purchaser-interactive device is a computer 51, preferably a personal computer, and more preferably a notebook computer, laptop computer or tablet computer. Oher processor-equipped devices well suited or configurable for use with at least part or all of a method of the present invention include single-board computers, e.g., Arduino(s), Raspberry Pi, etc. smart-devices, e.g., smartphones, and the like.

A preferred processor-equipped purchaser-interactive device 50 configured to carry out a method of the present invention implemented in software and/or firmware, e.g., stored onboard the device in memory or another data storage device, is a laptop or notebook computer 51 equipped with at least a trackpad 53, keyboard 55, and a display 57. Such a preferred processor-equipped purchaser-interactive device 50 can be and preferably is linked, e.g., wirelessly linked, to a network, a plurality of interconnected networks, as well as the Internet, e.g., a network of networks, enabling network interaction and/or control, e.g. remote interaction and/or control via such a network/Internet, thereof including via the Internet. Such a laptop or notebook purchaser-interactive device 50 configured for use at point-of-purchase can also include a keypad, a touchscreen, speakers, vibration outputting transducer(s) and/or a mouse, trackball, joystick, and/or game controller if desired or needed for facilitating purchaser interaction therewith during its use and operation. Display 57 can be or include an LCD or LED display screen that can be of touchscreen construction and/or include a touchscreen purchaser 44 can manipulate by touch during use and operation of device 50. Display 57 can be of virtual-reality construction with display 57 being at least part of or otherwise including a virtual-reality display, e.g., spherical 3-D virtual-reality display, which can be or include a head-mounted virtual reality display (not shown) worn by purchaser 44 if desired.

While purchaser-interactive device 50 can be configured in software and/or firmware to enable a purchaser 44 to manually enter anthropometric data, kiosk 42 can include or otherwise configured with an anthropometric data gathering device 64 disposed onboard kiosk 42 that can be used to obtain anthropometric data of the purchaser and/or help facilitate determination or measurement of purchaser anthropometric data. As is shown in FIG. 1, where kiosk 42 is equipped with onboard anthropometric data gathering device 64, device 64 can be mounted thereto such as by being attached to part of the frame 48 of the kiosk and preferably positioned to obtain purchaser anthropometric data during an anthropometric data gathering step while the purchaser 44 is located adjacent kiosk 42 and using purchaser-interactive device 50.

Such an onboard anthropometric data gathering device 64 is or communicates with a processor-equipped device like a desktop computer, laptop, notebook, tablet, smart-device, e.g., smartphone or the like, controller, e.g., programmable controller, or other type of computer, e.g., single board computer, Arduino, etc. having hardware, software and/or firmware configured to facilitate gathering, obtaining or determination of purchaser anthropometric data. Such an anthropometric data gathering device 64 can include one or more sensors, e.g., infrared and/or biometric sensors, scanners, e.g., infrared, laser, biometric, 3D body, or other type(s) of scanner(s), cameras, or other sensing, detecting, or measurement devices capable of or otherwise configured to sense, detect, measure or otherwise obtain anthropometric data of the purchaser including at least a plurality of different anthropometric data types, variables and/or parameters including preferably pertaining to at least a plurality of characteristics, parameters or the like of the body of the purchaser.

In a preferred embodiment and implementation, anthropometric data that includes at least a plurality of height, weight, arm length, inseam and/or leg length, waist, foot size, hand size, body mass index, body volume index, or the like are obtained, e.g., detected, sensed, measured, etc., or otherwise inputted, e.g., manually entered, into a preferred method of carrying out the invention that is implemented in software and/or firmware and preferably executed by apparatus. As discussed in more detail below, in one such preferred embodiment and implementation, anthropometric data used in a preferred implementation of a method of the present invention at least includes the height, weight, arm length, inseam, and waist of the purchaser interacting with apparatus to carry out the method.

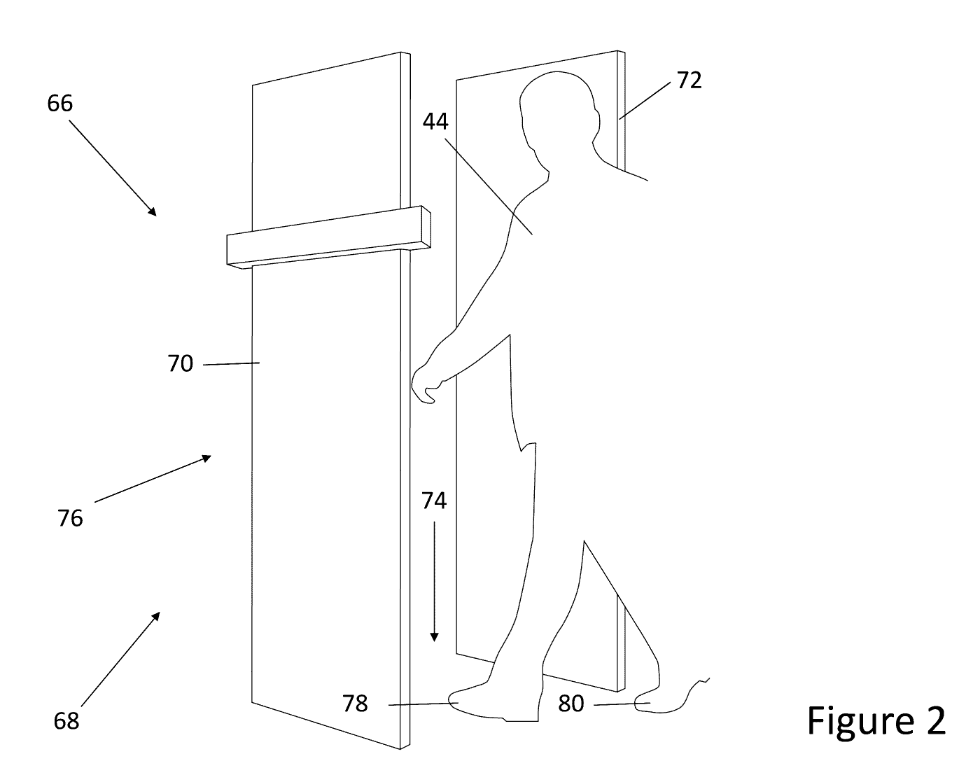

FIG. 2 illustrates a preferred embodiment of an anthropometric data gathering device 66 separate from kiosk 42 and purchaser-interactive device 50 that preferably includes a 3-dimensional body scanner 68 having one or more scanning or sensing panels 70, 72 spaced apart by a scanning platform 74 disposed therebetween on which purchaser 44 is located during 3-D body scanning of the purchaser 44. During a step of one preferred implementation of a method of the present invention where anthropometric data of the purchaser 44 is obtained, purchaser 44 interacts with anthropometric data gathering device 66 by entering anthropometric data scanner 76 that preferably is a three-dimensional body scanner 68 where scanner then scans the body of purchaser 44 to obtain anthropometric data of purchaser 44 used in the method.

In a preferred anthropometric data gathering method step, purchaser 44 enters scanner by positioning himself or herself between panels 70 and 72 with their feet 78, 80 resting on platform 74. During execution of anthropometric data gathering, purchaser 44 is scanned to obtain at least a plurality of height, arm length, inseam, and waist of the purchaser 44. In addition, platform 74 preferably is configured with or functions as a scale from which a weight or mass of the purchaser 44 also is obtained. In one such preferred anthropometric data gathering method step, scanner scans purchaser 44 while purchaser 44 is standing on platform 74 to thereby obtain height, weight, arm length, inseam and waist measurements of the purchaser 44.

Anthropometric data gathering device 66 can be configured, such as in software and/or firmware, to only scan and obtain anthropometric data from purchaser 44 upon purchaser 44 initiating execution of anthropometric data gathering. If desired, anthropometric data gathering device 66 can instead be configured to automatically scan and obtain anthropometric data of purchaser 44 upon purchaser 44 entering the scanner and standing on platform 74. Device 66 can be configured with one or more active or passive scanning arrangements or systems, e.g., laser, light, sonic, electric field, and/or infrared scanning arrangements or systems, used during anthropometric data gathering to scan purchaser 44, by scanning at least one side or face of the purchaser 44. In a preferred implementation of one such anthropometric data gathering device 66, device preferably is configured in hardware, software and/or firmware to scan a plurality of sides of purchaser 44 and/or to scan one or both of the front and/or rear of purchaser 44 to obtain the desired anthropometric data subsequently used in the method.

In addition to anthropometric data gathering device 66 being used to obtain such anthropometric data of purchaser 44, device 66 can also be used to obtain purchaser anthropometric data or enable use of purchaser anthropometric data obtained for providing or otherwise facilitating purchase recommendations of clothes, e.g., gloves, jackets, shirts and/or pants, riding accessories, protective equipment, e.g., helmets, boots, and/or riding chaps, and other types of goods purchaser 44 can use or wear during use and operation of bike or motorcycle. Such an anthropometric data gathering device 66 preferably is configured in hardware, software and/or firmware to not only be able to obtain height, waist, arm length and/or inseam, but also head or cap size, hand size, and and/or shoe or boot size where it is desired to be able to provide such other purchase recommendations to purchaser 44 later on.

If desired, anthropometric data gathering device 66 can be equipped with one or more cameras (not shown) that provide at least one or more of such height, waist, arm length and/or inseam of purchaser 44 during anthropometric data scanning. Where equipped with one or more cameras, one or more cameras can also be used to take a picture of purchaser 44, such as by taking one or more pictures of the face and/or head of purchaser 44, of the torso and/or legs of purchaser 44, etc. including to help facilitate purchase recommendations of clothes, e.g., gloves, jackets, shirts and/or pants, riding accessories, protective equipment, e.g., helmets, boots, and/or riding chaps, and other types of goods purchaser 44 can use or wear during use and operation of bike or motorcycle. Where equipped with one or more cameras, such an anthropometric data gathering device 66 preferably is configured in hardware, software and/or firmware to not only be able to obtain height, waist, arm length and/or inseam, but also head or cap size, hand size, and and/or shoe or boot size where it is desired to be able to provide such other purchase recommendations to purchaser 44 later on.

If desired, anthropometric data gathering device 66 can be configured in hardware, software and/or firmware to provide or otherwise obtain anthropometric data of purchaser 44 that can include or otherwise be used to obtain other types of anthropometric data of purchaser 44 including one or more of body type, e.g. somatotype, another type human variability-related anthropometric data, auxologic anthropometric data, such as in the case where purchaser 44 is not yet an adult, e.g. less than 18 years old, and still growing, and/or another type of anthropometric data. Where such additional anthropometric data of purchaser 44 is obtained during the anthropometric data gathering step, it preferably advantageously can be useful for enabling the method discussed in more detail below to take into account potential or even likely future physiological changes of purchaser 44 that will take place in the future in generating or determining one or more purchasing choices and/or customization options provided to purchaser 44.

In this regard, whether obtained prior to, during or after the anthropometric data gathering step, anthropometric data of the purchaser 44 preferably also is obtained and evaluated in carrying out the method of the invention also includes the age, e.g. age in years, of purchaser 44, and the sex, e.g. male or female, of purchaser 44. Where body type, e.g. somatotype, another type human variability-related anthropometric data, auxologic-related anthropometric data, such as where purchaser 44 is not yet an adult, e.g. less than 18 years old, and still growing, and/or another type of anthropometric data which relates to, takes into account or is used in predictive anthropometric data modeling of purchaser 44, e.g., in modeling future anthropometric data of purchaser 44 upon reaching adulthood, such a preferred implementation of the method of the present invention takes into account both the age and sex of purchaser 44 in doing so.

In one preferred embodiment, anthropometric data gathering device 66 is disposed adjacent kiosk 42 and positioned or otherwise located such that purchaser 44 can be scanned by the device 66 to obtain the anthropometric data 66 of the purchaser 44 while the purchaser is using or otherwise interacting with the kiosk 42. In such a preferred embodiment, anthropometric data gathering device 66 is located adjacent and forwardly of kiosk 42 such that a purchaser 44 using the purchaser-interactive device 50 has their feet 78 and 80 resting on platform 74 while they are not only interacting with kiosk 42 but also while being scanned to obtain anthropometric data of purchaser 44.

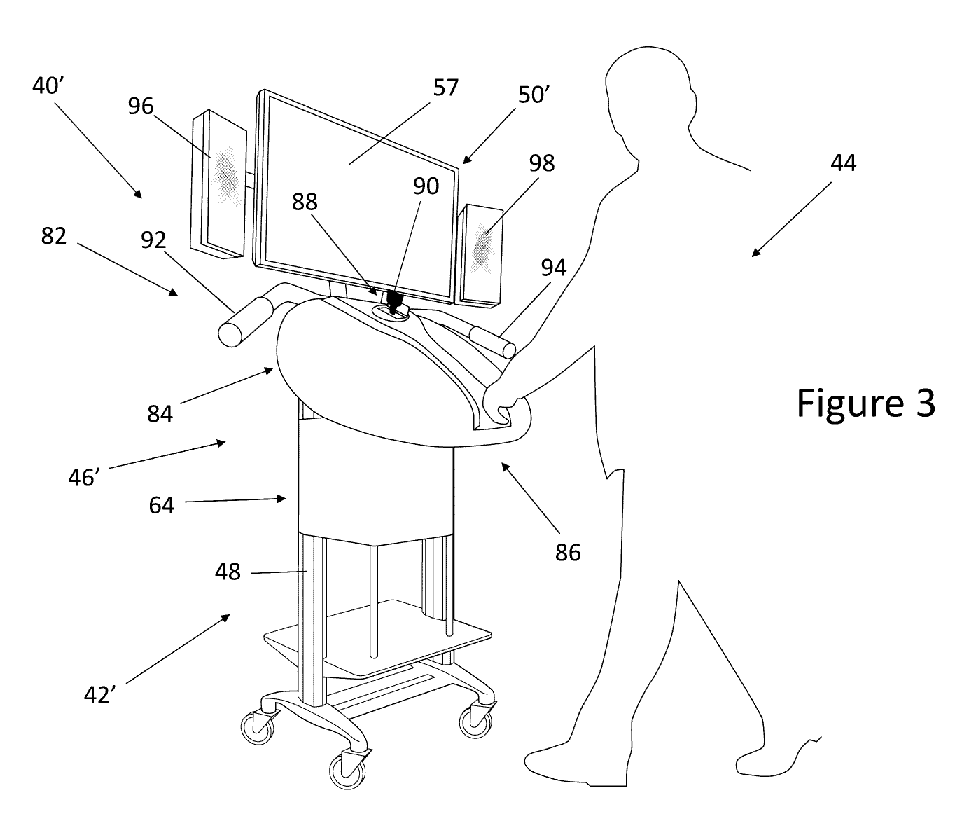

FIG. 3 illustrates another preferred embodiment of a kiosk 42′ that includes or is configured to provide a purchaser-interactive device 50′ that enables purchaser 44 to interact therewith in carrying out a method of the present invention with the kiosk 42′ preferably being configured in appearance to provide a look, feel and/or function of or related to the product of interest to purchaser 44 that also is related to the method. In the preferred embodiment of the product-tailored kiosk 42′ shown in FIG. 3, kiosk 42′ is configured with an appearance, e.g., three dimensionally configured or contoured, which at least partly mimics that of a motorbike having a pair of handlebars 82 extending outwardly adjacent to and/or from at least a portion of a generally upwardly purchaser-facing driver or operator console 84, e.g. dashboard, which can be configured to at least partially include and/or at least partially visually appear similar to a motorbike fuel tank 86, e.g. teardrop shaped motorcycle gasoline tank. Where equipped with handlebars 82, one or both handgrips 92 and/or 94 can include, be configured as or otherwise be equipped with a control and/or sensor usable not only by purchaser 44 during interaction with kiosk 42′ and/or purchaser-interactive device 50′ in carrying out a preferred implementation of a method of the present invention but which also can be used during or to facilitate obtaining of anthropometric data from purchaser 44.

Although not shown in FIG. 3, kiosk 42′ and/or purchaser-interactive device 50′ include a user data entry device, preferably a keyboard, keypad, trackpad, trackball, mouse, and/or pointer. While manual data entry by purchaser 44 or another user of kiosk 42′ and/or purchaser-interactive device 50′ can be done using a display 57 that is a touchscreen type display, kiosk 42′ and/or device 50′ can include one or more such aforementioned purchaser or user manipulable user data entry devices. Where equipped with such one or more purchaser or user manipulable data entry devices separate from display 57, one or more can be carried by, mounted to, integrally formed of, and/or integrally formed with part of console 84 and/or gas tank 86. Additionally, as discussed in more detail below, one or both handgrips 92 and/or 94 of the handlebars 82 of the motorbike-styled or motorcycle-appearing kiosk 42′ can also be configured to include one or more such purchaser or user manipulable data entry devices.

In addition, one or more handgrips 92 and/or 94 of handlebars 82 can include, be configured as or otherwise be equipped with a sensor that preferably is usable during the step of gathering anthropometric data of purchaser 44 which gathers one or more pieces, points or types of anthropometric data of purchaser 44 when purchaser is grasping the sensor equipped handgrip 92 and/or 94 during anthropometric data gathering. In one preferred embodiment, at least one of the handgrips 92 and/or 94 of handlebar 82 is equipped with a sensor that measures or facilitates measurement of body fat percentage, body mass index, temperature, and/or pulse of purchaser 44 gripping or otherwise contacting such a sensor-equipped handlebar during the anthropometric data gathering step. In another preferred embodiment, one or both handgrips 92 and/or 94 can be equipped with one or more other types of biometric sensors that measure or otherwise provide one or more other types of anthropometric data of purchaser 44 grasping handlebars 82 during the anthropometric data gathering step. Examples of such sensors include strain gauge sensors, such as to measure handgrip strength and/or hand twisting/torsion strength, piezoelectric sensors, such as to measure handgrip strength and/or hand twisting/torsion strength, and/or other types of active and/or passive anthropometric data providing or data measuring biometric sensors.

In addition, or in lieu thereof, such a kiosk 42′ equipped with handlebars 82 with handgrips 92 and 94 can be used as locators for purchaser 44 during the step of obtaining anthropometric data of purchaser 44 to help facilitate more accurate and more repeatable anthropometric data gathering. During the step of anthropometric data gathering where one or preferably both handgrips 92 and 94 of the handle bars 82 are used as locators, each hand of purchaser 44 grips a corresponding handgrip 92 and 94 of handlebar 82 thereby locating purchaser 44 relative to any scanner or camera of onboard or off-board anthropometric data gathering devices 64 and/or 66. In one preferred embodiment and anthropometric data gathering method, grasping of each handgrip 92 and 94 by purchaser 44 locates at least the two arms of purchaser 44 relative to one or more scanners, cameras and/or other sensors of anthropometric data gathering device(s) 64 and/or 66 thereby enabling repeatable, consistent and accurate measurement of purchaser arm length during execution of the anthropometric data gathering step. In one such preferred embodiment and anthropometric data gathering method, grasping of each handgrip 92 and 94 by purchaser 44 preferably also locates a torso, waist, legs, hands and/or feet of purchaser 44 relative to one or more scanners, cameras and/or other sensors of anthropometric data gathering device(s) 64 and/or 66 thereby enabling repeatable, consistent and accurate measurement of purchaser height, waist, inseam and/or one or more other pieces or types of anthropometric data during execution of the anthropometric data gathering step.

Where equipped with handlebars 82 where one or both handgrips 92 and/or 94 are equipped with a control, each handgrip control can be configured to enable or otherwise facilitate interaction of purchaser 44 with device 50′ including to select or facilitate selection, configuration and/or purchase of one or more bike or motorbike purchasing choices and/or one or more customization options for a particular purchaser selected one of the bikes or motorbikes. If desired, at least one of the handgrips 92 and/or 94 can be configured with a rotary control enabling purchaser 44 to select, configure and/or purchase one or more bike and/or motorbike purchasing choices and/or one or more customization options therefor. If desired, such a handgrip 92 and/or 94 can instead or also include a lever, e.g., throttle lever, control and/or joystick used to control use and operation of a preferred implementation of a method of the invention implemented in software and/or firmware by purchaser-interactive device 50′.

The console 84 can be and preferably is equipped with an ignition control 88 which can and preferably utilizes a key 90 that a purchaser 44 interacting therewith uses to manipulate the ignition control 88 such as preferably when initiating startup of purchaser-interactive device 50′ and/or method. Where so equipped, kiosk 42′ and/or purchaser-interaction device 50′ preferably also includes a purchaser interaction enticing feedback hardware arrangement that includes one or more speakers 96 and/or 98 which provide audio feedback to the purchaser 44 during use and/or interaction with kiosk 42′ and/or purchaser-interactive device 50′ including during execution of a preferred purchaser interaction enticing feedback method that uses the purchaser interaction enticing feedback hardware arrangement to help facilitate purchaser interaction therewith. Where so equipped, display 57 of device 50′ can also be part of and preferably is part of such a purchaser interactive feedback arrangement which preferably also includes software and/or firmware along with other hardware of the kiosk 42′ and/or device 50′ configured to not only help entice a prospective purchaser to interact with kiosk 42′ and/or device 50′ but which also is used in carrying out or facilitating carrying out the method. If desired, kiosk 42′, preferably purchaser-interactive device 50′, can be and preferably is configured with a motion sensor (not shown), such as a passive infrared motion sensor or the like, which senses movement of a person in a sensor window or sensor area adjacent kiosk 42′ and starts up a preferred implementation of a purchaser interaction enticing feedback method and/or starts up purchaser interaction enticing feedback arrangement.

Although not shown in FIG. 3, kiosk 42′ and/or anthropometric data gathering device(s) 64 and/or 66 can include or use a seat pressure detecting and/or mapping apparatus in the form of a seat, preferably a bike or motorcycle seat, upon which the purchaser 44 sits during the anthropometric data gathering step in order to obtain baropodographic-type anthropometric data of purchaser 44 pertaining to pressure points of their buttocks when seated, e.g., pressure point(s) of tuberosity of ischium, pressure points acting upon portions of the fire of each purchaser leg when seated and/or pressure points of their lumbar region when seated used in a preferred implementation of the method to help determine predictive posture and/or seat comfort of purchaser 44 in evaluating (a) one or more choices of bikes or motorbikes, and/or (b) one or more bike or motorbike customization options preferably including one or more bike or motorcycle seat choices. Such a sensor equipped vehicle seat, preferably bike seed or motorcycle seat, includes one or more integrated pressure sensors, e.g. piezoelectric and/or strain gauge pressure sensors, and/or other types of sensors usable to help produce at least a plurality of pairs, i.e. at least three, pressure measurements or pressure values at or along at least a plurality of pairs, i.e. at least three, spaced apart locations along the seat when purchaser 44 sits on the seat during the anthropometric data gathering step. In one preferred embodiment, such a baropodographic-type pressure and posture determining anthropometric sensing seat of the present invention preferably has an array of sensors, preferably pressure sensors, spaced apart along a fore-aft direction along each side of the sensing seat enabling at least a plurality, preferably at least a plurality of pairs, of pressure measurements or pressure values to be determined for each leg, each corresponding side of buttocks and/or each corresponding side of lumbar region of purchaser 44 sitting in the sensing seat during the anthropometric data gathering step. Although not shown in FIG. 3, kiosk 42′ can be further modified from that shown in FIG. 3 to be configured or further configured as an anthropometric data gathering bike or motorcycle test mule equipped with such a console 84, fuel tank 86, handlebars 88 with handgrips 92 and 94, a vehicle seat, preferably bike or motorcycle seat, with one or more of each equipped with at least a plurality of anthropometric data sensing, detecting or obtaining sensors as discussed herein.

In a preferred implementation of the method, key 90 is made available or otherwise obtained by purchaser 44 in seeking to evaluate (a) purchase of one or more choices of bikes or motorbikes and/or (b) purchase of one or more bike or motorbike customization options. It is contemplated that a sales associate or sales representative on the showroom floor or in the vicinity of the kiosk 42′ initially possess the key 90 in order to be able to offer it to prospective and actual purchasers potentially interested in (a) evaluating one or more bike or motorbike choices for actual or possible purchase and/or (b) evaluating one or more bike or motorbike customization options for actual or possible purchase.

When purchaser 44 uses key 90 manipulate control 88 in a manner effectively starting or turning on the kiosk 42′ and/or purchaser-interactive device 50′ in the same manner they would start a motorbike or motorcycle, doing so causes one or more method steps to be executed which not only capture the attention of the purchaser 44 but which also help prepare the purchaser 44 to carry out the rest of the method of the invention. In a preferred implementation, inserting the key 90 into the ignition 88 of kiosk 42′ not only turns on purchaser-interactive device 50′ and/or starts execution of the method, but it preferably also operates the purchaser interaction enticing feedback arrangement by carrying out a pre-method algorithm or series of steps that provides one or both of audio and/or visual feedback to the purchaser 44. In one such preferred implementation, turning the key 90 in the ignition switch 88 causes speakers 92 to output the sound of a motorcycle engine revving up or accelerating to help entice further interaction by purchaser 44. If desired, the purchaser interaction enticing feedback can be executed to cause the display 57 to provide visually perceptible purchaser interaction enticing feedback on the screen of the display 57, such as by playing an animated GIF, MPEG file, movie or the like of a motorcycle being driven or written by purchaser 44.

In another preferred implementation, kiosk 42′, preferably purchaser-interactive device 50′, is configured in software and/or firmware to play, e.g. continuously loop, and audio, visual, and/or audiovisual purchaser enticing message, animated GIF, and/or video outputted by the purchaser interaction enticing feedback arrangement that provides a sales conversation starter or introduction for a sales associate or sales representative to offer the key 90 to purchaser 44. In one such preferred implementation, a sound of a motorcycle engine revving is outputted from speakers 94 enabling a purchaser 44 in the vicinity of kiosk 42′ to hear the motorcycle engine sound enabling the sales associate or sales representative to offer the key 90 to purchaser 44. If desired, a purchaser enticing message, such as “Make it yours!™” can also be outputted, such as over speakers and/or shown on display 57, during execution of a preferred implementation of a purchaser interaction enticing method. If further desired, kiosk 42′, preferably purchaser-interactive device 50′, can be and preferably is configured with a motion sensor (not shown), such as a passive infrared motion sensor or the like which senses movement of a person in a sensor window or sensor area adjacent kiosk 42′ and starts up such a preferred implementation of a purchaser interaction enticing feedback method and arrangement.

When purchaser 44 inserts the key 90 into ignition 88 and turns the key 90, turning on the ignition 88, e.g., closing switch of ignition 88, a further audio, visual and/or audiovisual message can be outputted from speakers and/or display to purchaser 44 to not only further entice them into continuing to interact with kiosk 42′ and purchaser-interactive device 50′, but which also starts the method of the invention and lets purchaser 44 know the method of the invention has started.

Once the method of the invention has been initiated, an initial purchaser data gathering method step is executed to obtain, preferably by query, information about the purchaser 44, including their age, sex, e.g. male or female, as well as potentially other desired purchaser information including one or more of an email address, residential address, phone number, and/or other type(s) of data of personal to the purchaser 44. In one preferred implementation of such a personal data gathering method step, a purchaser account preferably is created as a result of carrying out the personal data gathering method step thereby advantageously enabling the account of the particular purchaser 44 to be updated each time purchaser 44 uses such a kiosk 42′ and/or 42 equipped with a purchaser-interactive device 50 or 50′ used to carry out the method of the invention. In addition, creation of such an account for each particular purchaser 44 who executes such a method of the invention also enables it to be accessed by the purchaser 44 remotely over the Internet. It is also contemplated that a preferred implementation of such a method of the invention is configured in software and/or firmware to enable a purchaser 44 to remotely create such an account using the Internet such as by accessing a webpage run on a remotely located Web server configured in software and/or firmware with a preferred implementation of the personal data gathering method step and/or method of the invention. Such personal purchaser data, including where a purchaser account is created, is stored in a database as is known in the art thereby enabling it to be accessed, analyzed, updated and the like, including over time by the purchaser 44 during subsequent uses of the method of the invention.

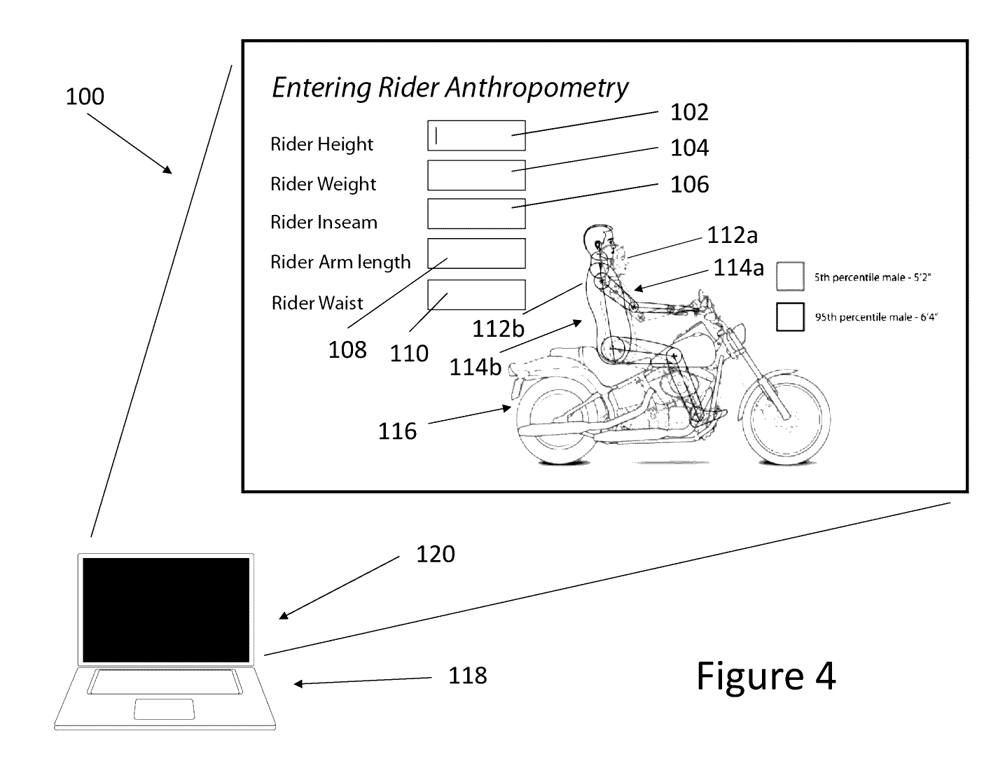

With reference to FIG. 4, where an anthropometric data gathering device is not present, a preferred implementation of a method of the present invention preferably includes a manual entry anthropometric data gathering or data entry step or an option to execute such a manual entry anthropometric data gathering or data entry step where the purchaser 44 is prompted to enter at least a plurality, preferably at least a plurality of pairs, of different types of anthropometric data of the purchaser 44. In one preferred manual anthropometric data entry step, a data entry screen 100 like that shown in FIG. 4 having at least a plurality of anthropometric data entry fields 102, 104, 106, 108 and/or 110 in which purchaser 44 enters their corresponding anthropometric data. In one such preferred manual anthropometric data entry step, at least the height 102, weight 104, inseam 106, arm length 108, and waist 110, of the purchaser 44, e.g., rider, are entered by or for the purchaser 44.

Using at least these values of anthropometric data of the height 102, weight 104, inseam 106, arm length 108, and waist 110, the method of the present invention generates a virtual model of the purchaser 44 that almost certainly will be a model at or between a 5^{th} percentile virtual rider model 112a and a 95^{th} percentile virtual rider model 112b shown in corresponding virtually modeled motorcycle riding postures 114a and 114b on a virtual motorcycle model 116 illustrated in FIG. 4. It is contemplated that additional implementations of the method will not only use purchaser or rider height 102, purchaser or rider weight 104, purchaser or rider inseam 106, purchaser or rider arm length 108, and purchaser or rider waist 110 in generating a virtual computer model of the purchaser 44 that is placed on a virtual computer model of a motorcycle selected by purchaser 44, e.g. virtual motorcycle model 116, and oriented in at least one riding posture, e.g. riding posture(s) 114a and/or 114b, but that additional anthropometric data of the purchaser 44 may also be taken into consideration.

Such additional anthropometric data can and preferably does include one or more of the following: forearm length, e.g. length of arm from wrist to elbow, brachium length, e.g., length of arm from elbow to shoulder, shoulder-to shoulder width, hand size, hand length, hand width, human body trunk length, cervical or neck length and/or width, head length and/or width, pelvic or pelvis width, upper leg or femur length, e.g., length of leg from hip to knee, lower leg or foreleg length, e.g., length of leg from knee to ankle, foot size, foot length, and/or foot width. In one preferred method implementation, at least a plurality of forearm length, e.g. length of arm from wrist to elbow, brachium length, e.g., length of arm from elbow to shoulder, shoulder-to shoulder width, hand size, hand length, hand width, human body trunk length, cervical or neck length and/or width, head length and/or width, pelvic or pelvis width, upper leg or femur length, e.g., length of leg from hip to knee, lower leg or foreleg length, e.g., length of leg from knee to ankle, foot size, foot length, and/or foot width of the purchaser 44 are taken into account or otherwise used in generating the virtual computer model of the rider or purchaser 44. In another such preferred method implementation, at least a plurality of height 102, weight 104, inseam 106, arm length 108, and waist 110 and at least a plurality of forearm length, e.g. length of arm from wrist to elbow, brachium length, e.g., length of arm from elbow to shoulder, shoulder-to shoulder width, hand size, hand length, hand width, human body trunk length, cervical or neck length and/or width, head length and/or width, pelvic or pelvis width, upper leg or femur length, e.g., length of leg from hip to knee, lower leg or foreleg length, e.g., length of leg from knee to ankle, foot size, foot length, and/or foot width of rider or purchaser 44 are used in generating the virtual computer model of the rider or purchaser 44. In still another such preferred method implementation, in addition to height 102, weight 104, inseam 106, arm length 108, and waist 110, at least a plurality of, preferably at least a plurality of pairs of, forearm length, e.g. length of arm from wrist to elbow, brachium length, e.g., length of arm from elbow to shoulder, shoulder-to shoulder width, hand size, hand length, hand width, human body trunk length, cervical or neck length and/or width, head length and/or width, pelvic or pelvis width, upper leg or femur length, e.g., length of leg from hip to knee, lower leg or foreleg length, e.g., length of leg from knee to ankle, foot size, foot length, and/or foot width of rider or purchaser 44 are used in generating the virtual computer model of the rider or purchaser 44 in carrying out a preferred method of the invention.

In a preferred implementation of a method of the present invention, such a manual entry anthropometric data gathering or data entry step is implemented or included where the method is carried out remote from any dealership, any retail establishment, or the like where no kiosk 42 or 42′ and/or purchaser-interactive device 50 or 50′ is present or available. In another preferred implementation of the method of the present invention, purchaser-interactive device 50 or 50′ can be configured in software and/or firmware to present purchaser 44 with such a manual entry anthropometric data gathering or data entry screen 100 when an anthropometric data gathering device 64 or 66 is not available, where anthropometric data of the purchaser 44 gathered by the anthropometric data gathering device 64 or 66 appears to be erroneous or requires subsequent accuracy verification, e.g. purchaser review and confirmation, and/or where otherwise desired, needed or required to carry out the method.

In one such method implementation where at least a portion of the method is carried out remotely or independently of any kiosk 42 or 42′ and/or purchaser-interactive device 50 or 50′, at least a portion of the method, including a manual entry anthropometric data gathering or data entry step, is included as part of a software application, e.g. app, which purchaser 44 can download and install on a processor equipped device 118 of their own choosing. During the manual entry step, a screen like the manual data entry screen 100 shown in FIG. 4 is displayed by a display of the processor equipped device 118 of purchaser 44 prompting purchaser 44 to enter the rider height 102, rider weight 104, rider inseam 106, rider arm length 108, and rider waste 110 of the purchaser 44. Processor equipped device 118 can be a computer like the notebook computer 120 shown in FIG. 4 or can be another processor equipped device, such as a smart phone, tablet, personal computer, or the like. This local application based implementation advantageously enables purchaser 44 to be able to execute the method of the present invention at the convenience of the purchaser 44, such as while at home or at work.

In another such method implementation where at least a portion of the method is carried out remotely or independently of any kiosk 42 or 42′ and/or purchaser-interactive device 50 or 50′, at least a portion of the method, including a manual entry anthropometric data gathering or data entry step, is accessed by purchaser 44 over the Internet by the purchaser 44 navigating to a website or webpage on a Web server configured in software and/or firmware to carry out at least such a portion of the method and which can be configured in software and/or firmware to carry out substantially the entire method. During the manual entry step, a screen like the manual data entry screen 100 shown in FIG. 4 is displayed by a display of the processor equipped device 118 of purchaser 44 prompting purchaser 44 to enter the rider height 102, rider weight 104, rider inseam 106, rider arm length 108, and rider waste 110 of the purchaser 44. Processor equipped device 118 can be a computer like the notebook computer 120 shown in FIG. 4 or can be another processor equipped device, such as a smart phone, tablet, personal computer, or the like. This web based implementation advantageously enables purchaser 44 to be able to execute the method of the present invention at the convenience of the purchaser 44, such as while at home or at work.

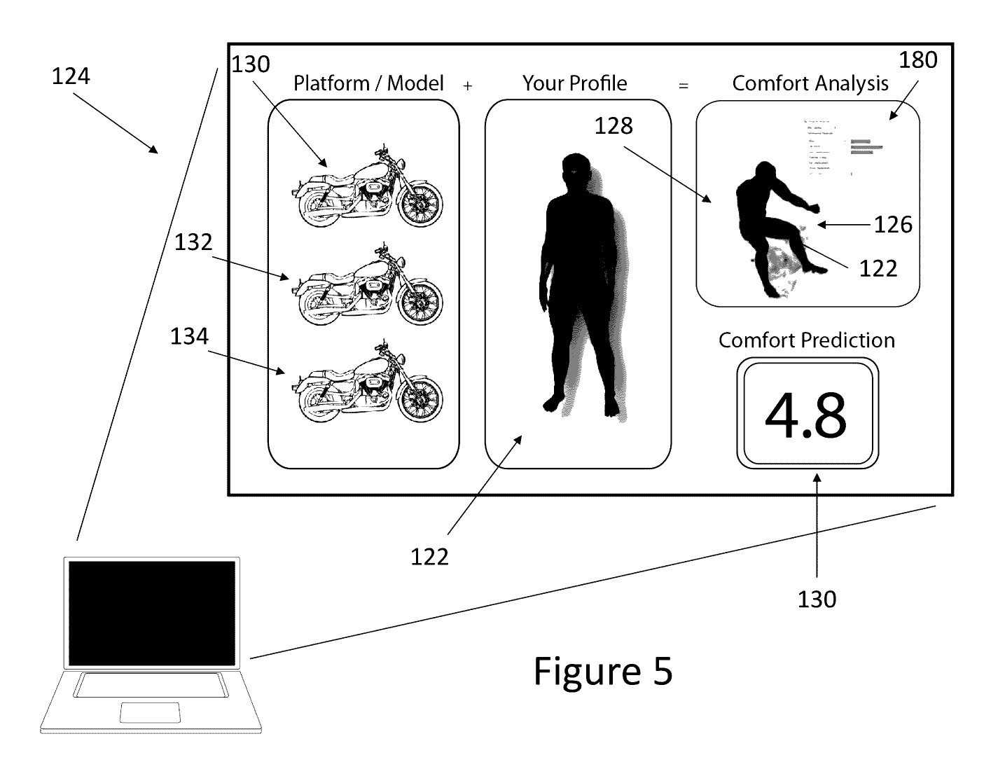

With reference to FIG. 5, once anthropometric data of the purchaser 44 is obtained, anthropometric data of the purchaser 44 is used in generating a virtual computer model, represented for example by avatar 122 shown on method display screen 124 in FIG. 5, of the purchaser 44 that is used in a posture fitting step or algorithm as part of a comfort analysis step or algorithm of the method to determine whether the virtual model of the purchaser 44 has a suitably acceptable predictive posture when virtually computer modeled as a motorcycle rider, preferably motorcycle operator or motorcycle driver, in a riding position 126 on a virtual computer model of or representative of a motorcycle 128 to determine whether an acceptable minimum comfort level results. In a preferred method implementation, carrying out the posture fitting step or algorithm and/or comfort analysis step or algorithm produces a comfort prediction value 130 based on the predictive posture of the purchaser 44 virtually modeled in a riding position 126 using the virtual model of the purchaser 44, generated based on their anthropometric data, when virtually mounted on such a riding position 126 on the virtual model of the motorcycle 128 being comfort evaluated.

The method preferably is configured in software and/or firmware to enable purchaser 44 to make at least a plurality of purchasing choice related selections or decisions, enter one or more purchasing related criteria, data or information and/or make one or more other selections, choices or data entries related in some aspect to the selection, purchase, likes or dislikes, comfort and/or other aspects of carrying out or executing the method in evaluating the purchase or customization of one or more goods to be evaluated for purchase, selecting one or more goods to be evaluated for comfort and/or purchase evaluation, selecting one or more features, components, component locations, component orientations, component arrangements, component layouts and/or the like for comfort and/or purchase evaluation, using anthropometric data of purchaser 44 in selecting or facilitating selection of one or more goods under consideration for purchase based on predictive posture and/or predictive comfort analysis, and/or using anthropometric data of purchaser in selecting or facilitating selection of one or more features, components, component locations, component orientations, component arrangements, component layouts and/or the like for a particular one or more goods under consideration for purchase based on predictive posture and/or comfort analysis using the posture fitting step(s) and/or algorithm(s) and/or comfort analysis step(s) and/or algorithm(s) of the inventive method. A currently preferred method preferably is configured in software and/or firmware to enable purchaser 44 to make at least a plurality of purchasing choice related selections or decisions of or related to one or more motorcycles 132, 134 and/or 136, enter one or more purchasing related criteria, data or information and/or make one or more other selections, choices or data entries related in some aspect to each selection, prospective purchase(s), actual purchase(s), like(s) or dislike(s), comfort and/or other aspects of carrying out or executing the method in evaluating the purchase or customization of one or more motorcycles 132, 134 and/or 136, selecting one or more motorcycles 132, 134 and/or 136 to be evaluated for comfort and/or purchase evaluation, selecting one or more motorcycle features, motorcycle components, motorcycle component locations, motorcycle component orientations, motorcycle component arrangements, motorcycle component layouts and/or the like for motorcycle comfort and/or purchase evaluation, using anthropometric data of purchaser 44 in selecting or facilitating selection of one or more motorcycles 132, 134 and/or 136 under consideration for purchase based on predictive posture and/or predictive comfort analysis, and/or using anthropometric data of purchaser in selecting or facilitating selection of one or more motorcycle features, motorcycle components, motorcycle component locations, motorcycle component orientations, motorcycle component arrangements, motorcycle component layouts and/or the like for a particular one or more motorcycles 132, 134 and/or 136 under consideration for purchase based on predictive posture and/or comfort analysis using the posture fitting step(s) and/or algorithm(s) and/or comfort analysis step(s) and/or algorithm(s) of the inventive method.

In still another preferred implementation of such a method of the present invention, bikes or bicycles are the focus of such a method implementation using the same method or substantially the same method discussed herein for motor bikes or motorcycles implemented for bikes or bicycles. As such, it should be recognized that one or more implementations of the method of the invention shown, disclosed and described herein is not only well suited for use with motorcycles and motorbikes, but also is well suited for use by a purchaser, e.g. purchaser 44, where bikes or bicycles are the goods being comfort evaluated by predictively modeling or evaluation predictive posture, riding position and/or sitting position, e.g., predicted or predictive position person is disposed in when using the good(s), for prospective or actual purchase and/or are the goods whose one or more customization options are being comfort evaluated for prospective or actual purchase in a like, similar or substantially same manner or way as for motor bikes or motorcycles.

In yet still another preferred implementation of such a method of the present invention, other types of vehicles can be the focus of such a method implementation using the same method or substantially the same method discussed herein for motor bikes or motorcycles implemented for each such other type of vehicle of interest. As such, it should be recognized that one or more implementations of the method of the invention shown, disclosed and described herein is not only well suited for use with motorcycles and motorbikes, but also is well suited for use by a purchaser, e.g. purchaser 44, where one or more such other types of vehicles are the goods being comfort evaluated for prospective or actual purchase by predictively modeling or evaluation predictive posture, riding position and/or sitting position, e.g., predicted or predictive position person is disposed in when using each vehicle(s), and/or are the vehicle(s) whose one or more customization options are being comfort evaluated for prospective or actual purchase in a like, similar or substantially same manner or way as for motor bikes or motorcycles. Such other types of vehicles include off-road vehicles, e.g., all-terrain vehicles, utility terrain vehicles, snowmobiles, and the like, on-road vehicles, e.g., cars, trucks, sport-utility vehicles (SUVs), crossover utility vehicles (CUVs), semi tractors, agricultural vehicles, e.g., tractors, harvesters, cultivators in the like, turf care equipment, e.g., lawnmowers, lawn tractors, rear engine riders, commercial turf care equipment, and/or golf course maintenance equipment, construction equipment, e.g., backhoes, front end loaders, bulldozers, excavators, skid steer equipment, mini-excavators, lift trucks, and the like, as well as marine or watercraft including boats, personal watercraft, e.g., JET SKIs, jet boats, aquatic motorbikes, and the like.

As such, while the disclosure, drawings and the like of the present application is generally directed to implementation and use of the method of the present invention with motorcycles and motorbikes, it should be recognized that that one or more preferred implementations of a preferred method of the present invention can be configured using/in hardware, software and/or firmware for use with bikes, bicycles, and other types of vehicles, including one or more of off-road vehicles, e.g., all-terrain vehicles, utility terrain vehicles, snowmobiles, and the like, on-road vehicles, e.g., cars, trucks, sport-utility vehicles (SUVs), crossover utility vehicles (CUVs), semi tractors, agricultural vehicles, e.g., tractors, harvesters, cultivators in the like, turf care equipment, e.g., lawnmowers, lawn tractors, rear engine riders, commercial turf care equipment, and/or golf course maintenance equipment, construction equipment, e.g., backhoes, front end loaders, bulldozers, excavators, skid steer equipment, mini-excavators, lift trucks, and the like, as well as marine or watercraft including boats, personal watercraft, e.g., JET SKIs, jet boats, aquatic motorbikes, and the like.

Returning once again to FIG. 5 and pertaining to further discussion regarding implementation of such a method of the present invention for use with motorcycles or motorbikes, such a method is advantageously versatile in helping a purchaser 44 select one or more motorcycles from a larger master set of at least a plurality of pairs, i.e. at least three, of virtually computer modeled motorcycles using a virtual computer model of the purchaser 44 generated using anthropometric data of the purchaser 44, preferably obtained during the anthropometric data gathering step. Where the purchaser 44 does not know which make and/or model/platform of motorcycle they want, a preferred implementation of the method performs a virtual posture fitting step on at least a plurality of pairs, i.e. at least three, of the master set of virtually modeled motorcycles using the anthropometric data virtually modeled purchaser to determine which one or more of the virtually modeled motorcycles of the master set provides a suitably acceptable predictive posture. In a preferred implementation of the method, the virtual posture fitting step preferably is performed on each make and model/platform of each motorcycle in the master set and the purchaser 44 is presented with a list, picture or avatar of each motorcycle having a suitably acceptable predictive posture. In one such preferred implementation, the virtual posture fitting step is performed and a comfort prediction determination is made, such as preferably using and/or based on predictive posture of the virtually fitted anthropometric data modeled purchaser, with only those motorcycles of the master set having a minimum comfort prediction value being listed, pictured or otherwise shown via avatar to purchaser 44 on a display screen of a processor equipped device being used by purchaser 44 to carry out the method.

With continued reference to FIG. 5, in carrying out a preferred implementation of the method of the present invention, the purchaser 44 is virtually mathematically modeled, e.g., 3-dimensionally virtually modeled, using anthropometric data of purchaser 44 to generate a virtual purchaser 122 or virtual model 122 of purchaser 44 that is virtually posture fitted to at least one motorcycle that is virtually mathematically modeled, e.g., 3-dimensionally virtually modeled, to generate a virtual motorcycle 128 or virtual model 128 of motorcycle in order to determine, e.g., calculate, whether a predictive posture 126 of the virtual purchaser 122 or virtual model 122 of purchaser 44 virtually posture fitted to the virtual motorcycle 128 or virtual model 128 of the motorcycle has a suitably acceptable predictive posture and/or a suitably high comfort prediction value 130. Method can be and preferably is configured to enable purchaser 44 to (a) select a subset of one or more motorcycles of a larger master set of at least a plurality of pairs, i.e., at least three, motorcycles which can be virtually modeled, virtually posture fitted and/or comfort evaluated to determine which one or more of the subset of purchaser selected motorcycles have a have a suitably acceptable predictive posture and/or suitably high comfort prediction value 130, and/or (b) virtually posture fit and/or comfort evaluate such a virtual purchaser 122 or virtual model 122 of purchaser 44 to each one of the motorcycles of the master set to determine a subset of which one or more of the motorcycles of the master set have a suitably acceptable predictive posture and/or suitably high comfort prediction value 130.

Data for or representing at least a plurality of pairs, i.e., at least three, of motorcycles defining such a master set of virtually modeled motorcycles is stored, e.g., pre-stored, in a database of the method that is accessed by processor-equipped device configured to carry out the method during execution of the method. Such digital virtual modeling data of such a master set of motorcycles which can be virtually modeled using such data preferably is stored in such a master motorcycle database and contains digital virtual modeling data of or for at least 5 motorcycles, preferably for at least 15 motorcycles, and more preferably for at least 25 motorcycles.

In one preferred method, the master motorcycle database is a digital computer database that stores digital data sufficient to virtually model at least a plurality of pairs of motorcycles, preferably contains digital data sufficient to virtually model at least five motorcycles, and more preferably contains digital data sufficient to virtually model at least ten motorcycles. In another preferred method, the master motorcycle database contains or stores digital data sufficient to virtually model at least a plurality of pairs of motorcycles, along with at least a plurality of models or platforms for each one of the plurality of pairs of motorcycles, contains or stores data sufficient to virtually model at least five motorcycles, along with data sufficient to model at least a plurality of models or platforms of each one of the five motorcycles, preferably contains or stores data sufficient to virtually model at least ten motorcycles, along with data sufficient to model at least a plurality of models or platforms of each one of the ten motorcycles, and more preferably contains or stores data sufficient to virtually model at least twenty-five motorcycles, along with data sufficient to model at least a plurality of models or platforms of each one of the twenty-five motorcycles.

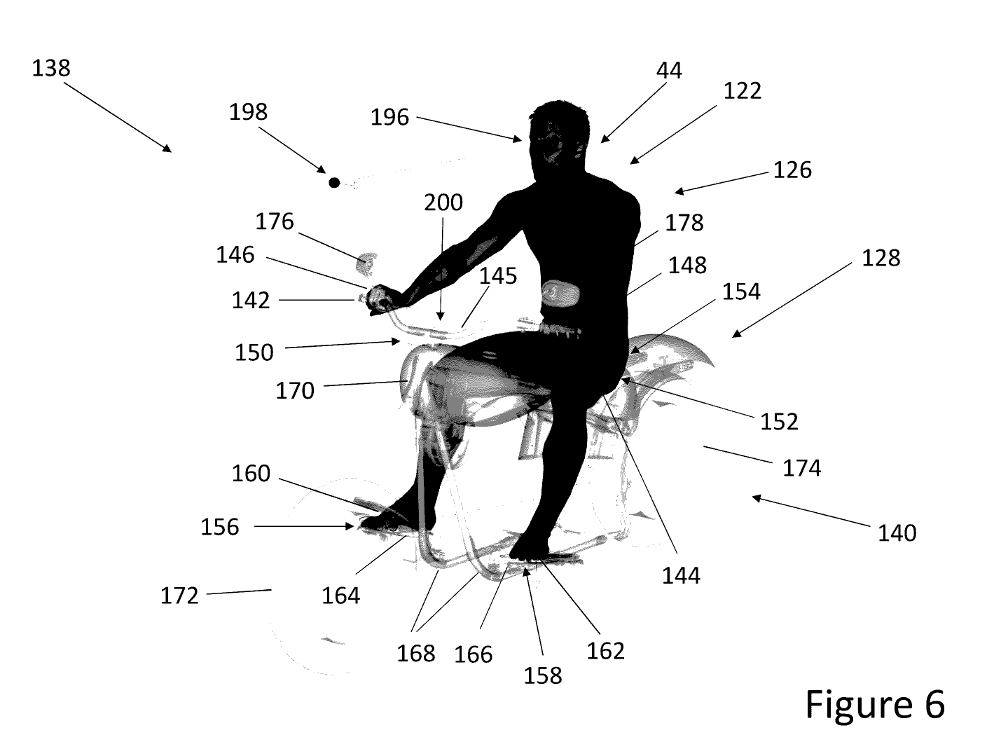

FIG. 6 illustrates visually a representation of virtual posture fitting 138 of a virtual three-dimensional model 122 of a purchaser 44 generated from anthropometric data of purchaser 44 to a virtual three-dimensional model 128 of a motorcycle 140 being comfort evaluated by or using the method to determine whether it results in a predictive virtual posture 126 that is suitably acceptable and/or which provides suitably high enough comfort prediction value 130 to be recommended to purchaser 44 in a subsequent recommendation step of the method. The virtual model 128 of the motorcycle 140 is generated from a set of data for the particular motorcycle being evaluated obtained from the master motorcycle database. Each data set of each motorcycle stored in the master motorcycle database preferably contains data for at least a plurality of the (a) locations of hand grips 142, 144 of handlebar 145 of motorcycle 140 which corresponding hand 146, 148 of virtual model 128 of purchaser 44 grasps when virtually fitted to the virtual model 128 of the motorcycle 140 in the riding position, (b) locations of mount(s) 150 of motorcycle 140 to which handlebar 145 or hand grips 142, 144 are attached, (c) location(s) of a seat 152 and/or seat index point (SIP) data for seat 152 mounted on motorcycle 140 upon which the buttocks 154 of virtual model 122 of purchaser 44 rests when sitting in seat 150 when virtually fitted to the virtual model 128 of the motorcycle 140 in the riding position, (d) locations of foot rests or foot pegs 156, 158 upon which respective feet 160, 162 of virtual model 122 of purchaser 44 rests when virtually fitted to the virtual model 128 of the motorcycle 140 in the riding position, and (e) locations of respective mounts 164, 166 to which foot rests or foot pegs 156, 158 are attached. In a preferred method of the present invention, each virtual motorcycle model data set for each motorcycle, including each platform or model of each motorcycle, includes location data for locations of at least a plurality of pairs, i.e., at least three, of the hand grips 142, 144, handlebar and/or hand grip mount(s) 150, seat 152 and/or SIP (and/or locations of mount(s) used to attach seat 152 to motorcycle 140, e.g., attached to frame or chassis of motorcycle 140), locations of foot rests or foot pegs 156, 158, and the locations of foot rest/foot peg mounts 164, 166. In another preferred method of the present invention, each virtual motorcycle model data set for each motorcycle, including each platform or model of each motorcycle, includes location data for the location of each of hand grips 142, 144, handlebar and/or hand grip mount(s) 150, seat 152 and/or SIP (and/or locations of mount(s) used to attach seat 152 to motorcycle 140, e.g., attached to frame or chassis of motorcycle 140), locations of foot rests or foot pegs 156, 158, and the locations of foot rest/foot peg mounts 164, 166. Such three dimensional modeling data for each such location or set of locations defining each such component, e.g., location(s) and/or surface(s) of virtual purchaser or virtual rider engagement, component mount, e.g., component mounting location(s), which ultimately define the virtual model 128 of each motorcycle, e.g., motorcycle 140, virtually modeled during posture fitting and/or comfort evaluation, is comprised of three dimensional location data for each that can be and preferably is relative to a reference location or an origin that is or provides a home or zero location, e.g., 0x, 0y, 0z, of the coordinate system used in three dimensionally modeling or generating the three dimensional model 128 of the motorcycle (and the virtual model 122 of purchaser 44).

Each motorcycle data set can also include data used to define hand grips 142, 144, seat 152, foot rests or pegs 156, 158, including as a surface or series of locations or points and/or as a three-dimensional object or volume, against or on which a corresponding body part of virtual model 122 of purchaser 44 bears, rests, contacts, grasps, or grips when virtually fitted to virtual model 128 of motorcycle 140 during posture fitting. Each motorcycle data set can also include data defining a frame or chassis 168 of motorcycle 140, data defining a three-dimensionally contoured surface of seat 152, e.g., three-dimensionally shaped seat saddle, teardrop-shaped gas tank 170, front tire and/or wheel 172, rear tire and/or wheel 174, mirrors 176, 178 and/or one or more other components of motorcycle 140 and/or including three dimensional location data for each that can be and preferably is relative to a reference location or an origin that is or provides a home or zero location, e.g., 0x, 0y, 0z, of the coordinate system used in three dimensionally modeling the motorcycle (and in three dimensionally modeling purchaser 44 using purchaser anthropometric data).

As previously discussed, anthropometric data of purchaser 44 obtained through an anthropometric data step using an anthropometric data measurement device, e.g., anthropometric data measurement device 64 and/or 66, and/or via entry of anthropometric data of purchaser 44, e.g., manual entry of purchaser anthropometric data such as by purchaser 44, preferably includes at least rider height, e.g., purchaser height, rider weight, e.g., purchaser weight, rider inseam, e.g., purchaser inseam, rider arm length, purchaser arm length, and rider waist, e.g., purchaser waist. At least this anthropometric data of purchaser 44 is used in and preferably is sufficient for generating a virtual model 122, e.g., 3-D and/or mathematical model, of purchaser 44 for use in mounting on the virtual model 128 of motorcycle, e.g., motorcycle 140, generated during posture fitting and/or comfort evaluation step(s) and/or algorithm(s) performed, executed or otherwise carried by or during execution of the method of the present invention.

As also previously indicated, additional anthropometric data of purchaser 44 can also be gathered, obtained, entered, etc. including: forearm length, e.g. length of arm from wrist to elbow, brachium length, e.g., length of arm from elbow to shoulder, shoulder-to shoulder width, hand size, hand length, hand width, human body trunk length, cervical or neck length and/or width, head length and/or width, pelvic or pelvis width, upper leg or femur length, e.g., length of leg from hip to knee, lower leg or foreleg length, e.g., length of leg from knee to ankle, foot size, foot length, and/or foot width. As previously indicated, at least a plurality, preferably at least a plurality of pairs, of forearm length, e.g. length of arm from wrist to elbow, brachium length, e.g., length of arm from elbow to shoulder, shoulder-to shoulder width, hand size, hand length, hand width, human body trunk length, cervical or neck length and/or width, head length and/or width, pelvic or pelvis width, upper leg or femur length, e.g., length of leg from hip to knee, lower leg or foreleg length, e.g., length of leg from knee to ankle, foot size, foot length, and/or foot width of the purchaser 44 can also be taken into account or otherwise used in generating the virtual model 122 of purchaser 44.

One or more methods of generating virtual models 122 and 128 of purchaser 44 and/or motorcycle, e.g., motorcycle 140, can be used including one or more such methods and/or modeling techniques or algorithms disclosed in U.S. Patent Application Publication No. 2010/0030532 A1, and/or article entitled Human Motion Planning Based on Recursive Dynamics and Optimal Control Techniques, pages 433-458, Multibody System Dynamics 8: 433-458: 2002, the entirety of each of which is expressly incorporated herein by reference. One or more such methods, techniques and/or algorithms disclosed in one or both of U.S. Patent Application Publication No. 2010/0030532 A1 and/or Human Motion Planning Based on Recursive Dynamics and Optimal Control Techniques can also be used in carrying out posture fitting and/or comfort evaluation in carrying out one or more such methods of the present invention, including in carrying out one or more aspects of such method(s) of the present invention. One or more such methods, techniques and/or algorithms disclosed in one or both of U.S. Patent Application Publication No. 2010/0030532 A1 and/or Human Motion Planning Based on Recursive Dynamics and Optimal Control Techniques can therefore be implemented in software and/or firmware as part of one or more such methods of the present invention implemented in software and/or firmware, including in implementing one or more aspects of such method(s) of the present invention in software and/or firmware.

In a preferred method of posture fitting and/or comfort evaluation, a virtual model 122 of purchaser 44 is mounted in at least one riding position on a virtual model 128 of motorcycle, e.g., motorcycle 140 of FIG. 6, and one or more posture and/or comfort related parameters are analyzed, determined and/or calculated using the virtually posture fitted rider-bike pair 180 virtually generated such as by or using processor-equipped device. Such parameters can and preferably do include one or more of the following: angle between torso and legs, e.g., hip flexor or flexure angle, angle of lean toward handlebars and/or hand grips of virtual motorcycle, angle and/or magnitude of knee bend, femur angle relative to horizontal and/or bike longitudinal axis, neck angle and/or bend, spine angle and/or curvature (and/or deviation from being straight or normal), wrist-forearm angle or bend, e.g. hand-forearm angle or bend, and/or ankle-foreleg angle or bend, e.g. foot-leg angle or bend.

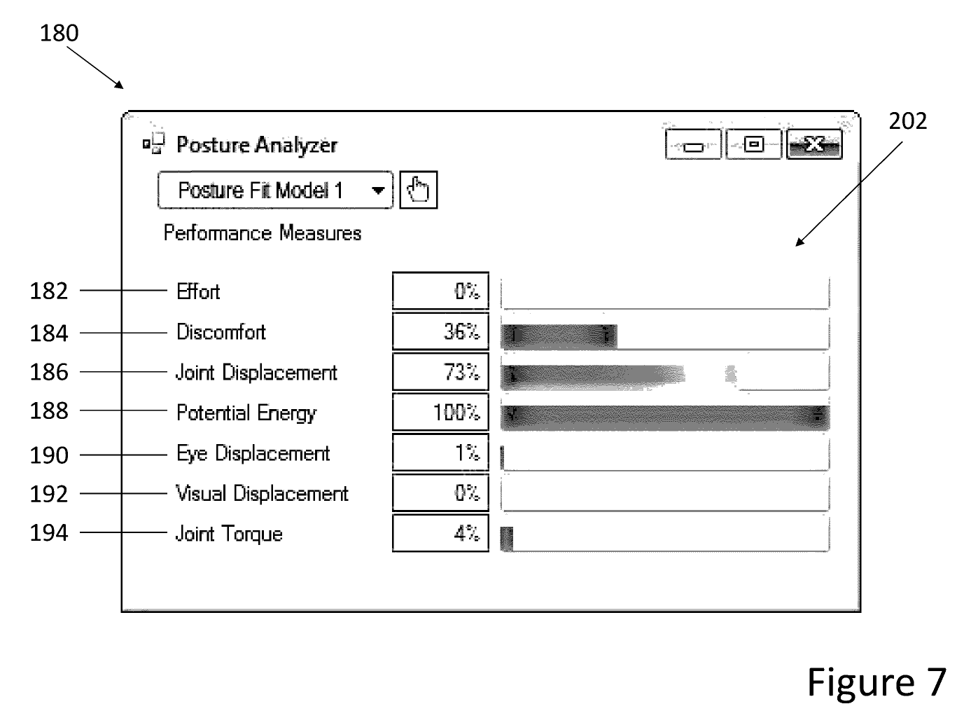

With additional reference to a posture analyzer output 180 shown in FIG. 7, such parameters can and preferably do include one or more of the following: a magnitude, value or percent(age) representing or related to an amount of effort 182 or estimated effort 182, e.g., mathematically calculated or estimated, which virtual model 122 of purchaser 44 exerts or is estimated to exert when virtually posture fitted in a virtual riding position, e.g., riding position 126, on virtual motorcycle, e.g., virtual motorcycle 140 (FIG. 6), a magnitude or value representing or related to potential energy 188 or estimated potential energy 188 when virtual model 122 of purchaser 44 is virtually posture fitted in a virtual riding position 126 on the virtual motorcycle 140, a magnitude, value or percent(age) representing or related to displacement 186 or estimated displacement 186 of one or more body joints, e.g., of a plurality of body joints, of virtual model 122 of purchaser 44 virtual posture fitted in virtual riding position 126 on virtual motorcycle 140, a magnitude, value or percent(age) representing or related to torque 194 or estimated torque 194 on or of one or more joints, e.g., a plurality of joints, of virtual model 122 of purchaser 44 virtual posture fitted in virtual riding position 126 on virtual motorcycle 140, an angle, magnitude, value or percent(age) representing or related to eye displacement 190 or estimated eye displacement 190 of eye(s) 196 of virtual model 122 of purchaser 44 virtual posture fitted in virtual riding position 126 on virtual motorcycle 140, an angle, magnitude, value or percent(age) representing or related to visual displacement 192 or estimated visual displacement 192 of virtual model 122 of purchaser 44 virtual posture fitted in virtual riding position 126 on virtual motorcycle 140, and/or a magnitude or value representing or relating to estimated or actual discomfort 184 purchaser 44 would predictively experience, e.g., be calculated or estimated to experience, when riding on such a motorcycle same as or substantially same as virtual model 128 of motorcycle 140 based on virtual model 122 of purchaser 44 virtually posture fitted in riding position 126 on virtual model 128 of motorcycle 140. With reference to both FIGS. 6 and 7, joint displacement 186 and/or joint torque 194 can be and preferably is determined or estimated for one or more of the hip joint(s), shoulder joint(s), knee joint(s) and/or neck of virtual model 122 of purchaser 44 when posture fitted in riding position, e.g., riding position 126, to virtual model, e.g., virtual model 128, of motorcycle, e.g., motorcycle 140.

With continued reference to FIGS. 5-7, eye displacement 190 and/or visual displacement 192 can be and preferably is determined relative to corresponding virtual visual reference points 198, 200 representative of where the eye(s) 196 of virtual model 122 of purchaser 44, i.e., virtual rider, virtually posture fitted in a virtual riding position, e.g., virtual riding position 126, on virtual model, e.g., virtual model 128, of motorcycle, e.g., motorcycle 140, focus when looking down the road when driving motorcycle 140 and when scanning console and/or instrument cluster of motorcycle 140 while riding motorcycle 140. In one method implementation, one of eye displacement 190 and visual displacement 192 is an angle, magnitude, value or percent(age) relating to visual reference point 198 of a location or area in front of virtual model 128 of motorcycle 140 where eye(s) 196 of virtual model 122 of purchaser 44, e.g., operator, driver or rider, virtually fitted to virtual model 128 of motorcycle 140 look(s) toward or focuses on when looking down the road while driving or operating motorcycle 140, and the other one of eye displacement 190 and visual displacement 192 is an angle, magnitude, value or percent(age) relating to visual reference point 200 of a location or area on virtual model 128 or motorcycle 140 where eye(s) 196 of virtual model 122 of purchaser 44, e.g., operator, driver or rider, virtually fitted to virtual model 128 of motorcycle 140 look(s) toward or focuses on when looking at console or instrument cluster of virtual model 128 of motorcycle 140 while driving or operating motorcycle 140. One or both eye displacement 190 and/or visual displacement 192 can be determined, calculated, estimated or otherwise based on an angle of eyes 196, head, forehead, and/or neck determined, calculated, and/or estimated when eyes 196 of virtual model 122 of purchaser 44 virtual fitted to virtual model 128 of motorbike 140 in virtual riding position 126 are focusing on a corresponding one of the visual reference points 198 or 200 relative to or in comparison with a baseline or optimal comfort norm or range where the riding position provides a known optimal posture, preferably for the particular motorcycle, e.g., motorcycle 140, being posture fitted and/or comfort evaluated in determine a respective performance measure for eye displacement 190 and 192 like that depicted in performance measures bar graph 202 shown in FIG. 7.

At least a plurality of posture and/or comfort related parameters, including at least one or more of the aforementioned above-described posture and/or comfort related parameters, more preferably at least a plurality of pairs of the aforementioned above-described posture and/or comfort related parameters are used in one of a predictive posture determination and/or comfort prediction value determination used to determine or in determining whether a particular virtual model, e.g., virtual model 128 in FIG. 6, of a motorcycle, e.g., motorcycle 140 of FIG. 6, will achieve a high enough predictive posture and/or comfort prediction value when posture fitting and/or comfort evaluation is performed using a virtual model, e.g., virtual model 122, of purchaser 44, generated based on or otherwise using purchaser's own anthropometric data for the motorcycle, e.g., motorcycle 140 of FIG. 6, to be recommended to purchaser 44. Where these parameters obtained from virtual posture fitting virtual model 122 of purchaser 44 to virtual model 128 of motorcycle 140 are used to determine comfort prediction value 130, motorcycle 140 will be recommended to purchaser 44 where its comfort prediction value 130 after such virtual posture fitting and/or virtual comfort evaluation is performed is greater than a predetermined minimum or threshold (or falls within a desired, e.g., predetermined, range) above which it is believed, estimated or known to correlate with acceptable comfort for actual purchaser 44 when riding the same actual motorcycle 140 in the real world equipped with the same actual handlebars 145, handgrips 142, 144, seat 152, and/or foot pegs or foot rests 158, 160 as virtually modeled and virtually posture fitted and/or virtually comfort evaluated using virtual model 122 of purchaser 44 generated from or based on purchaser's own anthropometric data.

In one preferred method or method implementation, each make, model and/or platform of motorcycle comfort analyzed using a method of comfort optimization in accordance with the present invention by virtually posture fitting and/or virtually comfort evaluating a virtual model 122 of purchaser 44 generated from purchaser's own anthropometric data virtually mounted on a virtual model 128 of each motorcycle desired to be evaluated is recommended to purchaser 44 for purchase consideration as predictively expecting to be suitably comfortable for that purchaser 44 (based on their anthropometric data) where the resultant comfort prediction value 130 is greater than a minimum value or threshold of 5.0. In another such preferred method or method implementation, each make, model and/or platform of motorcycle comfort analyzed using a method of comfort optimization in accordance with the present invention by virtually posture fitting and/or virtually comfort evaluating a virtual model 122 of purchaser 44 generated from purchaser's own anthropometric data virtually mounted on a virtual model 128 of each motorcycle desired to be evaluated is recommended to purchaser 44 for purchase consideration as predictively expecting to be suitably comfortable for that purchaser 44 (based on their anthropometric data) where the resultant comfort prediction value 130 is greater than a minimum value or threshold of 6.0.

In a preferred method or implementation of a method of determining which one of a larger set of motorcycles would have a suitably acceptable predictive posture, e.g. predictive virtual posture level, and/or comfort prediction value 130 in carrying out such a method of the present invention, virtual posture fitting and/or virtual comfort evaluation can be performed for a plurality of locations, angles, orientations and/or adjustments that can be made thereto, for each one of a plurality of the handlebar(s) 145, handgrips 142 and/or 144 of the handlebar(s) 145, foot rests or foot pegs 156 and/or 158, and/or seat 152. In such a preferred implementation of such virtual posture fitting and/or virtual comfort evaluation steps, an iterative procedure or series of method steps can be carried out to change, e.g. incrementally change, one of a location, angle, orientation and/or adjustment, e.g. length or size adjustment, thereof for one of handlebar(s) 145, handgrips 142 and/or 144 of the handlebar(s) 145, foot rests or foot pegs 156 and/or 158, and/or seat 152, thereby virtually posture fitting virtual model 122 of purchaser 44 to virtual model 128 of motorcycle 140 in a riding position for each one of the incremental changes to the location, angle, orientation and/or length or size adjustment of whatever one of the handlebar(s) 145, handgrips 142 and/or 144 of the handlebar(s) 145, foot rests or foot pegs 156 and/or 158, and/or seat 152 being iteratively changed in this manner.

In one such preferred method implementation, the amount of handlebar rise and/or handlebar pullback for the particular set of handlebars 145 virtually modeled and virtually mounted to virtual model 128 of motorcycle 140 is incrementally changed during each virtual posture fitting iteration with virtual model 122 of purchaser 44 posture fitted thereon in a riding position that typically changes at least slightly during each posture fitting iteration. If desired, such a method implementation can perform at least one, preferably at least a plurality and more preferably at least a plurality of pairs of posture fitting iterations for each incremental change in (a) rise and/or (b) pullback of the virtually modeled handlebars 145 virtually modeled and virtually mounted to virtual model 128 of motorcycle 140 with a predictive posture, e.g. predictive posture level, and/or comfort prediction value 130 determination made for each posture fitting iteration with the handlebar rise and/or pullback setting or value producing the most optimal predictive posture and/or comfort prediction value 130 being outputted to purchaser 44 at the end in providing one or more comfort customization recommendations.

In such a preferred method implementation, an amount of forward offset and/or rise of the foot rests and/or foot pegs 156, 158 can be and preferably also is incrementally varied or adjusted during carrying out of at least a plurality, preferably at least a plurality of pairs, of virtual posture fitting and/or virtual comfort evaluation iterations of the method of the present invention to determine an optimal set or range of foot rest or foot peg forward offset and/or rise settings or adjustments that result in virtual model 122 of purchaser 44 having a suitably acceptable and/or comfortable virtual riding position on virtual model 128 of motorcycle 140 resulting in a suitably acceptable predictive posture, e.g. predictive posture level, and/or a suitably high comfort prediction value 130. In such a preferred method implementation, an amount of seat rise of the seat 152 can be and preferably also is incrementally varied or adjusted during carrying out of at least a plurality, preferably at least a plurality of pairs, of virtual posture fitting and/or virtual comfort evaluation iterations of the method of the present invention that results in virtual model 122 of purchaser 44 having a suitably acceptable and/or comfortable virtual riding position of a plurality, preferably at least a plurality of pairs, of virtual riding positions on virtual model 128 of motorcycle 140 virtually comfort evaluated during the multiple posture fitting iterations.

If desired, in addition to comfort prediction value 130, the results of and/or output for one or more other or additional comfort-related parameters, such as one or more of the parameters 182-194 of posture analyzer output 180, can also be displayed for each motorcycle, including each make, model and/or platform of each motorcycle, comfort analyzed using the method of the present invention to perform such a virtual posture fitting and/or virtual comfort evaluation thereon using such a purchaser anthropometric data-based virtual rider or operator model 122. In one preferred method implementation, in addition to comfort prediction value 130, at least a plurality of the aforementioned above-described posture and/or comfort related parameters can also be displayed on a display screen viewable to purchaser 44. In one such preferred method implementation, in addition to comfort prediction value 130, at least a plurality of the parameters 182-194 of posture analyzer output 180 are also displayed together with comfort prediction value 130 on a display screen, such as display screen 124 of FIG. 5, which is viewable to purchaser 44. In another such preferred method implementation, in addition to comfort prediction value 130, each one of the parameters 182-194 of posture analyzer output 180 are also displayed together with comfort prediction value 130 on a display screen, preferably display screen 124 of FIG. 5, which is viewable to purchaser 44. In addition, it is contemplated that purchaser analyzer output 180 be provided as a graphic element, window, or the like that can be included with other graphic elements, window(s), text, values, numbers, avatars, 3-D models or the like on one or more display screens of the present method.

Such a posture analyzer output 180, such as in the form of a graphic, graph, window or screen, can be presented for viewing by purchaser 44 for each motorcycle and/or each make, model and/or platform of each motorcycle comfort analyzed using the method of the present invention. If desired, such a posture analyzer output 180 can instead be presented for viewing by purchaser 44 for each motorcycle and/or each make, model and/or platform of each motorcycle comfort analyzed using the method of the present invention having a predictive posture, e.g., predictive posture level, and/or comfort prediction value 130 below the desired predetermined minimum, threshold and/or falling outside the desired predetermined range. Finally, if desired, such a posture analyzer output 180 can also be presented for viewing by purchaser 44 for each motorcycle and/or each make, model and/or platform of each motorcycle comfort analyzed using the method of the present invention having a predictive posture, e.g., predictive posture level, and/or comfort prediction value 130 at or above the desired predetermined minimum, threshold and/or which falls within the desired predetermined range.

The comfort optimization method of the present invention can also be used to virtually try out one or more customizations of a desired motorcycle, e.g. motorcycle 140, sought to be customized by purchaser 44. As such, the comfort optimization method of the present invention is not only well suited for use by prospective and actual purchasers, but is also particularly well suited for a purchaser 44 who already owns their own motorcycle, e.g. motorcycle 140, and wishes to customize their own motorcycle or further customize their own motorcycle by changing one or more of a plurality of customizable options. As a result, it is therefore contemplated to provide a comfort optimization method of the present invention enabling virtual customization of at least a plurality of different customization options or customizable options for each motorcycle of its custom motorcycle database in a manner where purchaser 44 is able to virtually “try out” each customization option on a desired motorcycle, such as a motorcycle they own, and have virtual posture fitting and/or virtual comfort evaluation performed to obtain a predictive posture and/or comfort prediction value 130 for each customization option virtually mounted on the motorcycle.

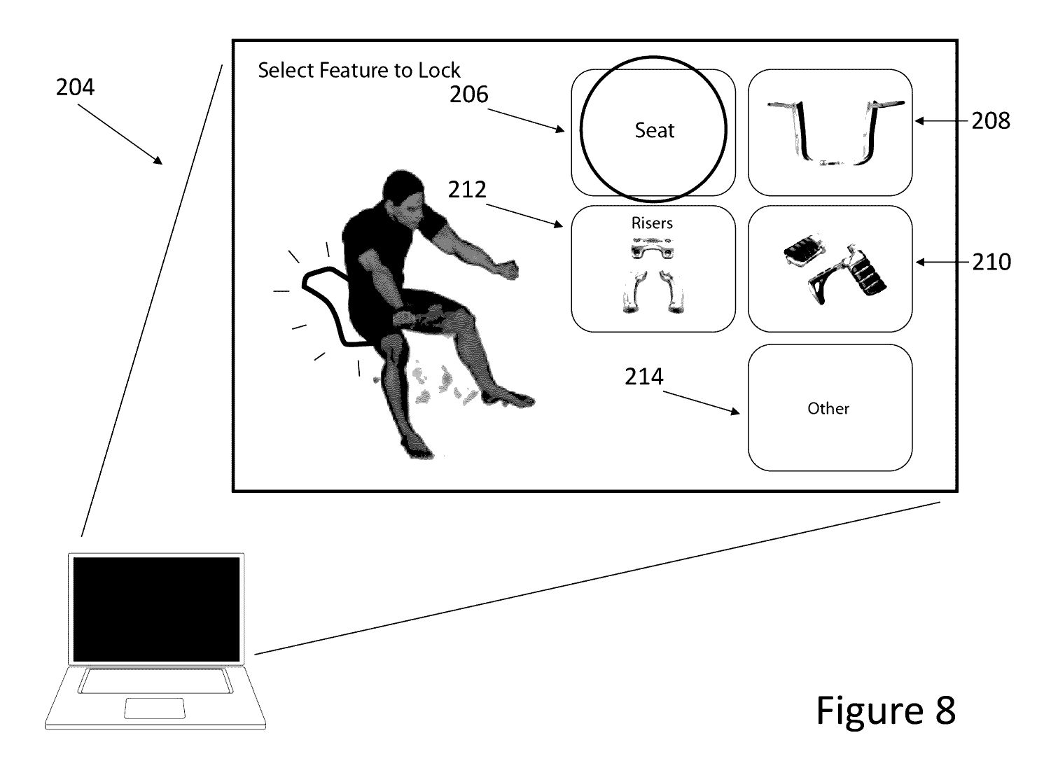

With reference to FIG. 8, a preferred but exemplary implementation of a comfort optimization method in accordance of the invention illustrates a screen 204 configured to enable a purchaser 44 interacting with processor-equipped device configured to carry out at least a portion of the method to be able to customize a particular desired motorcycle (as well as a plurality of motorcycles) by being able to choose from at least a plurality, preferably at least a plurality of pairs, i.e. at least three, of customization option categories 206, 208, 210, and/or 212. In the present case where the goods subject to comfort optimization in carrying out the method of the present invention are motorcycles, a first one of the customization option categories is a seat customization option category 206, a second one of the customization option categories is a handlebar option category 208, a third one of the customization option categories is a foot peg or foot rest option category 210, and a fourth one of the customization option categories is a riser or risers option category 212 as depicted in FIG. 8. If desired, the method can also be configured in software and/or firmware such that the customization option category selection screen 204 has a still further more general option category 214 designated “Other” for enabling the purchaser 44 to be presented with at least a plurality, preferably at least a plurality of pairs, i.e. at least three, of less common customization options of a typed different than the rest of the option categories 206, 208, 210 and/or 212 purchaser viewable on screen 204.

The processor equipped device depicted in FIG. 8 with customization option category selection screen 204 on its display 57 can be a purchaser-interactive device 50 or 50′, such as computer 51 or 51′, constructed in hardware and/or configured in software and/or firmware in accordance with that discussed above to carry out one or more or all of the steps or portions of the comfort customization method of the invention and which can be part of kiosk 46 or 46′. The processor equipped device depicted in FIG. 8 can also be such a processor equipped device as discussed above used remotely by purchaser 44, such as at home, in the office, or elsewhere, to carry out one or more all of the steps or portions of the method.

In one preferred method implementation, purchaser selection of the “Other” customization option category 214 can be used to present purchaser 44 with one or more customization options which each do not need to be comfort analyzed using the method because they do not affect or otherwise impact purchaser 44, e.g., operator or driver, posture or comfort. Examples of types of motorcycle customization options which do not fit into any option category impacting operator or driver posture or comfort include motorcycle side saddle bags, motorcycle fairing(s), windshield(s), chrome accessories, exhaust components, racks and other luggage holders, lighting, and/or mirrors. In another preferred method implementation, purchaser selection of the “Other” customization option category 214 can instead or also be used to present purchaser 44 with at least a plurality, preferably at least a plurality of pairs, i.e. at least three, of clothing options, clothing types, and/or clothing categories, where any type or piece of clothing presented to purchaser 44 as a result of automatic execution of the method and/or selected by purchaser 44 is chosen or custom fitted to purchaser 44 using anthropometric data of purchaser 44.

Where such an option is provided to enable clothing selection, as a result of having such anthropometric data of purchaser 44, one or more clothing options, clothing types and/or clothing categories can be analyzed using a virtual clothing fitting step, steps and/or algorithm(s) during method execution to provide one or more, preferably at least a plurality, and more preferably at least a plurality of pairs, of pieces of clothing using purchaser anthropometric data that can be custom fitted, custom tailored, or otherwise customized/custom-made for purchaser 44 using and/or based on anthropometric data of purchaser 44 obtained during execution of the method. As such, clothing options, clothing types and/or clothing categories related to the types of goods that are the subject of comfort optimization using such a method of the present invention preferably are presented to or made available for being presented to purchaser 44 upon selection of option category 214. In the present case, such clothing options, clothing types and/or clothing categories include motorcycle jackets, e.g., leather jackets, nylon jackets, protection reinforced jackets, etc.; motorcycle pants, e.g. leather pants, cloth/fabric pants, chaps, protection reinforced pants, etc.; motorcycle footwear, e.g., boots, shoes, etc., headgear, e.g. helmets, hats, etc.

As a result of having such anthropometric data of purchaser 44, a preferred implementation of a method of the present invention advantageously enables use of such anthropometric data of purchaser 44 to virtually, preferably three dimensionally, model the purchaser 44 in a manner that shows in three dimensions, e.g., three-dimensional avatar of purchaser 44 with piece(s) of virtually modeled clothing virtually worn by purchaser avatar, what they would look like wearing each piece of clothing, each one of a plurality of pieces of clothing, recommended automatically by method and/or selected by purchaser 44 based on purchaser anthropometric data. Such a three dimensional purchaser avatar preferably would not only be visually displayed in three dimensions on a display screen, e.g. LCD display, LED display, virtual reality display, etc. wearing one or more such purchaser anthropometric data fitted pieces of clothing and therefore be visible to actual purchaser 44, but the three dimensional purchaser avatar can also be virtually mounted on a three-dimensional virtual model, e.g. virtual model 122, of motorcycle, e.g. motorcycle 140, also visually displayable to purchaser 44 so purchaser 44 can see how he or she looks on the motorcycle when wearing one or more such pieces of virtual clothing. Such a virtual clothing and three-dimensional model display step can be carried out after all comfort optimization steps have been carried out to virtually posture fit and/or virtually comfort evaluate motorcycle(s) and/or customization options so any three-dimensional avatar of purchaser 44 virtually fitted with one or more pieces of virtual clothing is virtually mounted on one or more final comfort approved motorcycle(s) and/or motorcycle(s) with comfort approved customization option(s).

Where such an implementation of the method includes clothing customization options, clothing customization types, and/or virtual clothing fitting and/or virtual custom fitting of clothing, such an implementation of the method of the present invention can be further configured in software and/or firmware to serve as a portal to one or more clothing vendors, retailers, or the like who have custom clothing manufacturing capabilities, custom tailored clothing offerings and/or the like. This enables a purchaser equipped device configured in software and/or firmware to at least carry out such clothing related steps of the method of the present invention to not only serve as a point-of-purchase terminal or device for such clothing purchases but which also can then automatically communicate the anthropometric data of purchaser 44, namely those measurements of purchaser 44, e.g., height, weight, arm length, inseam, waist and/or any one of the other aforementioned above discussed anthropometric measurements and/or types of anthropometric data, via email, text message, SMTP, FTP, or via Internet using another digital data communications means to the vendor, retailer, custom clothing maker, tailor or other entity responsible for making or having made such customized for custom tailored clothing for purchaser 44.

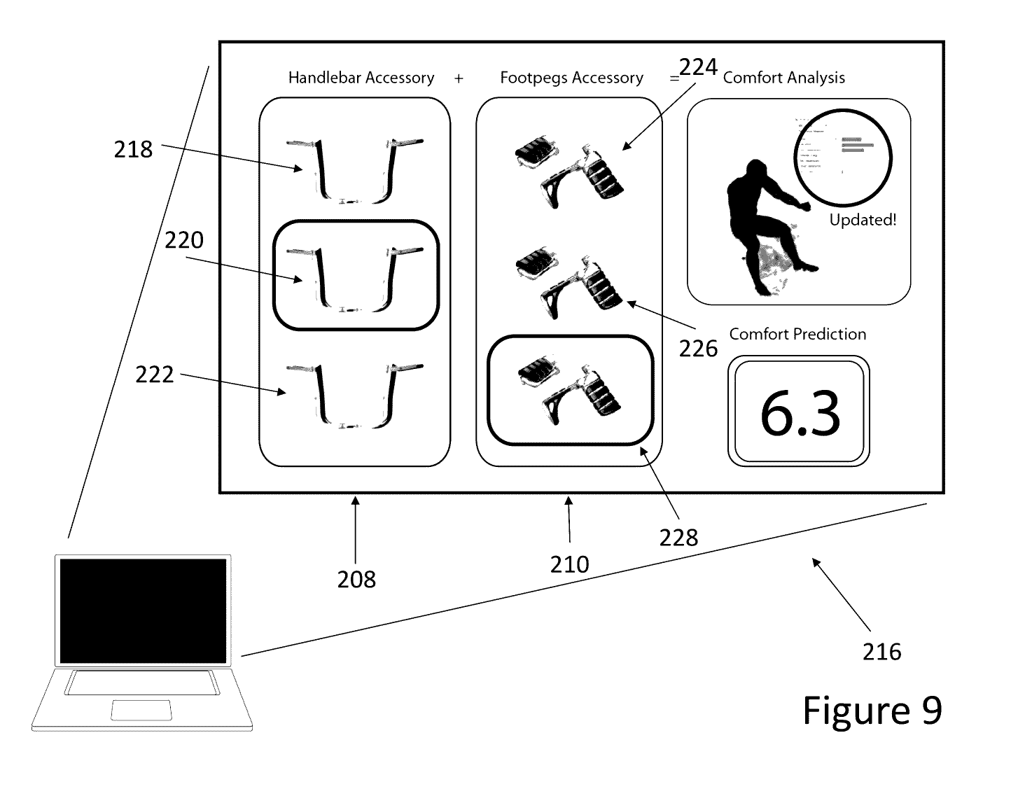

With additional reference to FIG. 9, each customization option category 206, 208, 210 and/or 212 enables the purchaser 44 to select from at least a plurality, preferably at least a plurality of pairs, i.e. at least three, of customization options using a customization option selection screen 216 like that shown in FIG. 9 for each customization option category 206, 208, 210 and/or 212 previously selected by purchaser 44 using the customization option category selection screen 204 of FIG. 8 in order to comfort evaluate and preferably comfort optimize customization of one or more selected or desired motorcycles with one or more customization options using the comfort optimization method of the present invention. In such a preferred method implementation, at least a plurality and preferably at least a plurality of pairs of customization options are visually presented to purchaser for consideration and/or selection for each one or more customization option categories 206, 208, 210 and/or 212 previously selected by purchaser 44.

In carrying out a preferred implementation of the comfort optimization method of the present invention, once the purchaser 44 selects one or more customization category options from the options 206, 208, 210, 212 and/or 214 purchaser selectable in or using the customization option category selection screen 204 of FIG. 8, the method is configured in software and/or firmware to the replace screen 204 with the customization option selection screen 216 of FIG. 9 to enable purchaser 44 to make specific customization option selections. When interacting with either screen 204 and/or 216, purchaser 44 preferably manipulates or otherwise interacts with a user input device, such as a mouse, trackball, pointer, gesture sensor, game controller, or the like, to make the desired selections, such as by pointing and clicking on each desired selection using the user input device.

With specific reference to FIG. 9, where the handlebar accessory category option 208 and foot pegs accessory category option 210 was selected by purchaser 44 using the customization option category selection screen 204 of FIG. 8, method is configured in software and/or firmware to subsequently present purchaser 44 with customization option selection screen 216 of FIG. 9. With regard to the specific customization option selection screen 216 shown in FIG. 9, because purchaser 44 selected the handlebar accessory customization option category 208 and the foot peg accessory customization option category option 210 when interacting in, with or using customization option category selection screen 204 of FIG. 8, method is configured in software and/or firmware to present at least a plurality, preferably present at least a plurality of pairs, of handlebar customization options 218, 220 and/or 222 for handlebar option category 208 in screen 216 of FIG. 9 and to present at least a plurality, preferably present at least a plurality of pairs, of handlebar customization options 224, 226 and/or 228 for foot peg option category 210 in screen 216 of FIG. 9.

In a preferred implementation of a method of comfort optimization customization of a motorcycle of the present invention, purchaser 44 preferably selects one of a plurality of customization options of each one of a plurality of purchaser selected customizations option categories to virtually customize a desired or purchaser selected motorcycle with a first set or combination of customization options. With particular reference to FIG. 9, purchaser has selected a second handlebar 220 or second handlebar customization option 220 from a plurality of pairs, i.e. at least three, of handlebars 218, 220 and 222 or handlebar customization options 218, 220 and 222 and has also selected a third set of foot pegs 228 or third foot peg customization option 228 from a plurality of pairs, i.e. at least three, of foot pegs 224, 226 and 228 or foot peg customization options 224, 226 and 228 to produce it a first set of customizations to be virtually modeled and/or virtually mounted to a desired or selected motorcycle, e.g. motorcycle 140.

In performing virtual posture fitting and/or virtual comfort evaluation of such a customization of motorcycle 140, the original or OEM handlebars and foot pegs of the base model or base platform of the motorcycle 140 are replaced with the purchaser selected set of handlebars 220 and the purchaser selected set of foot pegs 228. In performing virtual posture fitting and/or virtual comfort evaluation of such a motorcycle 140 customized with handlebars 220 and foot pegs 228, data virtually modeling, virtually locating and/or virtually orienting handlebars 220 and foot pegs 228 are retrieved from data storage or memory, e.g. from a database of virtual modeling data for purchaser customizable options in each of the customizable option categories 206, 208, 210, and/or 212, and used to generate and virtually mount handlebars 220 and foot pegs 228 to their respective mounting locations 150, 166 of virtual model 128 of motorcycle 140.

In carrying out the method with the virtual model of the selected handlebars 220 and virtual model of the selected set of foot pegs 228 virtually mounted to the virtual model 128 of motorcycle 140, the position, location, angle and/or orientation of one or both handlebars 220 and/or foot pegs 228 are iteratively changed during each virtual posture fitting and/or virtual comfort evaluation iteration to determine which one or range of at least a plurality of and more preferably at least a plurality of pairs of iteratively changed values of position, location, angle and/or orientation provide or result in a suitably acceptable predictive posture, e.g., predictive posture level, and/or comfort prediction value 130. In a preferred method implementation, where a set of handlebars, e.g., handlebars 220, is selected during purchaser 44 customizing motorcycle 140 to purchaser's tastes, at least a plurality and preferably at least a plurality of pairs, i.e., at least three, of virtual posture fitting and/or virtual comfort evaluation iterations of the method are preferably performed with the value or setting of at least one or both of (a) handlebars rise and/or (b) handlebars pullback incrementally changed during each iteration. Sufficient iterations can be and preferably are performed until a desired range of values or settings of one or both (a) handlebars rise and/or (b) handlebars pullback are incremented over the desired range obtaining a predictive posture, e.g., predictive posture level, and/or comfort prediction value 130 for each iteration and/or each increment over the desired range.

A predictive posture, e.g., predictive posture level and/or comfort prediction value 130 is obtained as discussed above for each iteration and either the particular handlebar rise and/or handlebars pullback value or range of values or settings which provides (a) the most optimal predictive posture, e.g. predictive posture level, and/or comfort prediction value 130 is stored, retained, and/or presented to purchaser 44, and/or (b) each suitably acceptable value or range are stored, retained and/or presented to purchaser 44. Where stored or retained, those optimal values, settings or ranges thereof for the set of handlebars, e.g., handlebars 220, iteratively comfort optimized in this manner can be compared with or against other such stored or optimal values, settings or ranges for one or more other sets of handlebars, e.g., handlebars 218 and/or 222, with only those handlebar(s) having values, settings or ranges that impart or provide motorcycle 140 with suitably acceptable predictive posture(s), e.g., predictive posture level(s), and/or suitably high enough comfort prediction values 130 to be presented to purchaser 44.

In a preferred method implementation, where a set of foot pegs, e.g., foot pegs 228, is selected during purchaser 44 customizing motorcycle 140 to purchaser's tastes, at least a plurality and preferably at least a plurality of pairs, i.e., at least three, of virtual posture fitting and/or virtual comfort evaluation iterations of the method are preferably performed with the value or setting of at least one or both of (a) peg forward offset and/or (b) peg rise incrementally changed during each iteration. Sufficient iterations can be and preferably are performed until a desired range of values or settings of one or both (a) foot peg forward offset and/or (b) foot pet rise are incremented over the desired range obtaining a predictive posture, e.g., predictive posture level, and/or comfort prediction value 130 for each iteration and/or each increment over the desired range.

A predictive posture, e.g., predictive posture level and/or comfort prediction value 130 is obtained as discussed above for each iteration and either the particular foot peg offset and foot peg rise value or range of values or settings which provides (a) the most optimal predictive posture, e.g. predictive posture level, and/or comfort prediction value 130 is stored, retained, and/or presented to purchaser 44, and/or (b) each suitably acceptable value or range are stored, retained and/or presented to purchaser 44. Where stored or retained, those optimal values, settings or ranges thereof for the set of foot pegs, e.g., foot pegs 228, iteratively comfort optimized in this manner can be compared with or against other such stored or optimal values, settings or ranges for one or more other sets of foot pegs, e.g., foot pegs 224 and/or 226, with only those foot peg(s) having values, settings or ranges that impart or provide motorcycle 140 with suitably acceptable predictive posture(s), e.g., predictive posture level(s), and/or suitably high enough comfort prediction values 130 to be presented to purchaser 44.

Where a seat is chosen or is also chosen by purchaser 44, in such a preferred method implementation, where one seat of a plurality or plurality of pairs of available seats is selected during purchaser 44 customizing motorcycle 140 to purchaser's tastes, at least a plurality and preferably at least a plurality of pairs, i.e., at least three, of virtual posture fitting and/or virtual comfort evaluation iterations of the method are preferably performed with the value or setting of seat rise incrementally changed during each iteration. Sufficient iterations can be and preferably are performed until a desired range of values or settings of seat rise are incremented over the desired range obtaining a predictive posture, e.g., predictive posture level, and/or comfort prediction value 130 for each iteration and/or each increment over the desired range.

A predictive posture, e.g., predictive posture level and/or comfort prediction value 130 is obtained as discussed above for each iteration and either the seat rise value or range of values or settings which provides (a) the most optimal predictive posture, e.g. predictive posture level, and/or comfort prediction value 130 is stored, retained, and/or presented to purchaser 44, and/or (b) each suitably acceptable value or range are stored, retained and/or presented to purchaser 44. Where stored or retained, those optimal values, settings or ranges thereof for the seat iteratively comfort optimized in this manner can be compared with or against other such stored or optimal values, settings or ranges for one or more other seats with only those seats having values, settings or ranges that impart or provide motorcycle 140 with suitably acceptable predictive posture(s), e.g., predictive posture level(s), and/or suitably high enough comfort prediction values 130 to be presented to purchaser 44.

A similar or like iterative procedure can be carried out where the purchaser 44 selects one or more risers from option 212 during motorcycle customization by purchaser 44 to provide to purchaser each riser and/or riser settings or values which provide a suitably acceptable predictive posture, e.g., posture level, and/or suitably high comfort prediction value 130. Although not shown in the drawing figures, sissy bars, seat pillions, suspension(s), suspension setting(s), suspension travel, suspension travel setting(s), and other components and settings can be included in the comfort optimization method and iteratively posture fitted and/or comfort evaluated in a like manner. In addition, the method, apparatus and system of the present invention can be configured in software and/or firmware to perform comfort customization, including posture fitting and/or comfort evaluation, of a passenger or rider separately and/or together with purchaser 44 if desired.

The present invention contemplates implementing the method, apparatus and system in a manner that provides 3-D images of the virtual model of purchaser 44 together with the virtual model of the motorcycle, including as virtually customized by purchaser 44, on a display of the processor equipped device, e.g., kiosk, during one or more steps of execution of the method in a manner where purchaser can rotate, zoom in, zoom out, etc., The present invention contemplates implementing the method, apparatus and system in a manner that provides purchaser 44 with a virtual reality immersive comfort optimization solution where purchaser 44 can use a virtual reality simulator, headsets, e.g., Oculus Rift, or the like to enable purchaser 44 to not only virtually see the virtual model of the motorcycle including as-customized by purchaser 44 in a 3-D virtual reality environment but also virtually sit on and even virtually ride the virtual model of the motorcycle including as-customized by purchaser 44.

The present invention is directed to a method of evaluating comfort or fit of a motorcycle that includes virtually fitting a virtually modeled person using anthropometric data of an actual person, such as a real prospective purchaser, to a virtually modeled motorcycle to obtain a predictive estimate relating to comfort therefrom. One aspect of the method includes the step of providing a processor-equipped device in communication with a display configured to virtually model the person using anthropometric data of the person, virtually model the motorcycle using a plurality of measurements, dimensions or parameters of the motorcycle, virtually fit the virtual model of the person to the virtual model of the motorcycle, show on the display a representation of the virtually modeled person on the virtually modelled motorcycle, and show on the display the predictive estimate relating to comfort obtained from virtually fitting the virtually modeled person to the virtually modeled motorcycle. In such a method, the processor-equipped device is in communication with the display configured to (a) obtain anthropometric data of the person, (b) enable the person to select at least one of a plurality of different motorcycles, and (c) enable the person to select at least one of a plurality of motorcycle accessories to customize the selected one of the plurality of different motorcycles. The method further includes the processor-equipped device being linked with or configured to access data containing measurements, dimensions or parameters for a plurality of different motorcycles needed to virtually model each one of the plurality of different motorcycles. In such a method, the processor-equipped device can be and preferably is linked with a data input device and/or configured to access data containing measurements, dimensions or parameters for a plurality of different motorcycle accessories needed to virtually model each one of the plurality of different motorcycle accessories. In once such method, the processor-equipped device is linked with a data input device and/or configured to access data containing measurements, dimensions or parameters for a plurality of different motorcycle handlebars needed to virtually model each one of the plurality of different motorcycle handlebars. For each one of the different motorcycle handlebars, the processor-equipped device is configured to virtually model each one of a selected one of the plurality of different motorcycle handlebars and virtually fit the virtual model of the selected one of the plurality of different motorcycle handlebars to the virtual model of the motorcycle.

The processor-equipped device can be and preferably is linked with a data input device and/or otherwise configured to access data containing measurements, dimensions or parameters for a plurality of different motorcycle seats needed to virtually model each one of the plurality of different motorcycle seats. For each one of the different motorcycle seats, the processor-equipped device is configured to virtually model each one of a selected one of the plurality of different motorcycle seats and virtually fit the virtual model of the selected one of the plurality of different motorcycle seats to the virtual model of the motorcycle.

The processor-equipped device can be and preferably is linked to a data input device and/or configured to access data containing measurements, dimensions or parameters for a plurality of different motorcycle foot pegs needed to virtually model each one of the plurality of different motorcycle foot pegs. For each one of the different motorcycle foot pegs, the processor-equipped device is configured to virtually model each one of a selected one of the plurality of different motorcycle foot pegs and virtually fit the virtual model of the selected one of the plurality of different motorcycle foot pegs to the virtual model of the motorcycle.

The processor-equipped device is linked with a data input device and/or configured to access data containing measurements, dimensions or parameters for a plurality of different motorcycle risers needed to virtually model each one of the plurality of different motorcycle risers. For each one of the different motorcycle risers, the processor-equipped device is configured to virtually model each one of a selected one of the plurality of different motorcycle risers and virtually fit the virtual model of the selected one of the plurality of different motorcycle risers to the virtual model of the motorcycle.

In a preferred method and embodiment, the processor-equipped device further includes an anthropometric data gathering device, such as a scanner, scale, a biometric data gathering, biometric data scanning or biometric data input device, configured for scanning or measuring one or more parameters, preferably at least a plurality of parameters, of the person to obtain anthropometric data of the person used to virtually model the person that preferably is sufficient to produce a virtual 3-D model of the person. In one such preferred method and embodiment, the anthropometric data gathering device is configured to scan or measure the person to obtain at least one of a height, weight, inseam, arm length and waist of the person for use in virtually modeling the person. A preferred anthropometric data gathering device is configured to scan or measure the person to obtain at least a plurality of the height, weight, inseam, arm length and waist of the person for use in creating a 3-D virtual model of the person. In a preferred method and embodiment, the processor-equipped device is a kiosk configured for retail display with the display linked to the processor-equipped device and having at least one data-input or data-entry device to enable data input by the person.

In one such preferred method and embodiment, the processor-equipped device is in communication with a display, preferably linked to the display, and is part of a kiosk configured for retail display, with the processor-equipped device configured to (a) obtain anthropometric data of the person, and (b) enable the person to select at least one of a plurality of different motorcycles to virtually model. The processor-equipped device preferably has at least one data-input or data-entry device to enable input of anthropometric data of the person by the person. In a preferred embodiment, the processor-equipped device is configured in software and/or firmware to permit the person to permit a data input device, such as a keyboard, touch sensitive tablet, mouse, or another manipulable data input device, to be used by the person to input at least a plurality of different anthropometric parameters or pieces of data to be used in creating a virtual model of the person suitable for fitting, preferably posture fitting, onto a virtual model of a motorcycle to determine a predictive estimate of comfort resulting from the posture fitting to be used by the person in helping determine suitability of the motorcycle and/or an accessory of the motorcycle.

In a preferred motorcycle comfort or fit evaluation method, the processor-equipped is configured in software or firmware to execute the following steps: (a) virtually model the motorcycle using a plurality of measurements, dimensions or parameters of the motorcycle to form a virtual model of the motorcycle; (b) virtually model a person evaluating comfort or fit of the motorcycle using anthropometric data of the person to form a virtual model of the person; (c) virtually fit the virtually modeled person to the virtually modeled motorcycle in an operating or riding position; and (d) obtain a predictive estimate relating to comfort or ergonomics based thereon that is predictive of actual comfort or ergonomics of the actual person mounted on the actual motorcycle in the operating or riding position. In one such preferred method, the predictive estimate is obtained by calculation and/or using a predictive comfort evaluation or determination model, preferably a posture fit model, which assesses at least one and preferably at least a plurality of (a) effort, (b) discomfort, (c) joint displacement, (d) potential energy, (e) eye displacement, (f) visual displacement, and/or (g) torque of the virtual model of the person fitted, preferably posture fitted, on the virtual model of the motorcycle. In a preferred implementation of this method, (i) the virtually modeled person is a 3-D model of the person made using anthropometric data of the person, and (ii) the virtually modeled motorcycle is a 3-D model of the motorcycle made using the plurality of measurements, dimensions or parameters of the motorcycle. In one such preferred implementation, the virtual model of the person is virtually fitted to or on the virtual model of the motorcycle in one of an operating or riding position on the virtually modeled motorcycle where the virtual model of the person is virtually engaged with or virtually mounted on the virtual model of the motorcycle in the one of the operating or riding position. In such a method implementation, at least one, preferably at least a plurality, and more preferably at least a plurality of pairs, i.e., at least three, of (a) effort, (b) discomfort, (c) joint displacement, (d) potential energy, (e) eye displacement, (f) visual displacement, and/or (g) torque of the virtual model are determined, estimated, and/or calculated in determining a predictive estimate of comfort for the virtual model of the person fitted to, e.g., mounted on, the virtual model of the motorcycle in an operating or riding position.

In a preferred implementation of the method, the virtual model of the person is virtually fitted to or on the virtual model of the motorcycle in one of a plurality of virtual operating or riding positions where the virtual model of the person is engaged with or mounted on the virtual model of the motorcycle in each one of the plurality of virtual operating or riding positions, and a predictive estimate is made relating to one of comfort or ergonomics for each one of the plurality of virtual operating or riding positions. The virtually modeled person preferably is virtually fitted to or on a virtually modeled seat of the virtual model of the motorcycle in one of a driver and passenger position on the virtually modeled seat of the virtual model of the motorcycle. In one such method implementation, the virtually modeled person is virtually fitted to or on a virtually modeled seat of the virtual model of the motorcycle in the driver position on the virtually modeled seat of the virtual model of the motorcycle. In another such method implementation, the virtual model of the person is virtually posture fitted to or on the virtual model of the motorcycle in a plurality of operating or riding positions, and a predictive estimate relating to comfort of the virtually modeled person is made for each one of the plurality of operating or riding positions. A determination or estimate relating to comfort preferably is made for each one of the plurality of riding positions or operating positions.

In a preferred implementation, at least one aspect, feature, component, angle, location, adjustment, or setting of the virtual model of the motorcycle is changed before, during or after each virtual posture fitting of the virtual model of the person on the virtual model of the motorcycle, and a determination or estimate relating to one of ergonomics and comfort is made for each one of the posture fittings. In one such method implementation, a plurality of aspects, features, components, angles, locations, adjustments, or settings of the virtual model of the motorcycle are changed before, during or after each virtual posture fitting of the virtual model of the person in at least one riding position or operation on the motorcycle, and a determination or estimate relating to one of ergonomics and comfort is made for each riding or operating position of each virtual posture fitting.

In a preferred implementation of a method of the present invention involving at least one motorcycle accessory that preferably is a motorcycle handlebar, the method includes performing the following additional steps: (a) virtually attaching a virtually modeled handlebar to the virtual motorcycle in an initial handlebar position, handlebar location, handlebar angle, handlebar adjustment, or handlebar setting; (b) virtually fitting the virtually modeled person to the virtual model of the motorcycle in a riding or operating position with the virtually modeled handlebar virtually attached to the virtual motorcycle in the initial position, handlebar location, handlebar angle, handlebar adjustment, or handlebar setting; (c) making a first determination or estimate relating to one of ergonomics and comfort for the virtually modeled person virtually fitted to the virtual model of the motorcycle in a riding or operating position with the virtually modeled handlebar virtually attached to the virtual motorcycle in the initial handlebar position, handlebar location, handlebar angle, handlebar adjustment, or handlebar setting; (d) virtually attaching the virtually modeled handlebar to the virtual motorcycle in a second handlebar position, handlebar location, handlebar angle, handlebar adjustment, or handlebar setting disposed from the initial handlebar position, handlebar location, handlebar angle, handlebar adjustment, or handlebar setting; (e) virtually fitting the virtually modeled person to the virtual model of the motorcycle in a riding or operating position with the virtually modeled handlebar virtually attached to the virtual motorcycle in the second handlebar position, handlebar location, handlebar angle, handlebar adjustment, or handlebar setting; and (f) making a second determination or estimate relating to one of ergonomics and comfort for the virtually modeled person virtually fitted to the virtual model of the motorcycle in a riding or operating position with the virtually modeled handlebar virtually attached to the virtual motorcycle in the second handlebar position, handlebar location, handlebar angle, handlebar adjustment, or handlebar setting.

The present invention is directed to a method, apparatus and system for enabling a purchaser to virtually try out a consumer good that preferably is a motorcycle before actually deciding to buy with such a method enabling an anthropometric measurement based virtual model of purchaser to virtually try on or virtually try out the consumer good, preferably by virtually sitting on and/or virtually riding a virtual model of a motorcycle, including any variations, customizable features, user-selectable options, accessories, adjustments and/or settings thereof to determine whether the consumer good, including any variation(s), customizable feature(s), user selectable option(s), accessories, adjustment(s) and/or setting(s) would provide a more optimal and preferably suitably predicted experience for purchaser that would result in a predictive comfort estimate being generated or obtained that provides purchasing feedback. A preferred apparatus is a kiosk for point of purchase or retail use that is visually configured in a manner that represents the consumer good, preferably a motorcycle, available for virtually try before purchase by purchaser virtually modeled to virtually use or operate the consumer good in a virtually modeled use or operating position. A preferred system includes a database of at least a plurality of pairs of virtually modeled consumer goods, at least a plurality of different motorcycle types, motorcycle makes and/or motorcycle models, along with at least a plurality of pairs of virtually modeled or virtually variable variations, accessories, customizable features, user-selectable options, adjustments, and/or settings which a virtually modeled purchaser can virtually mount, virtually be fitted to or with, virtually try on, or otherwise virtually try out before purchase.

Such a method, apparatus and system can be used to find which one of at least a plurality of or a plurality of pairs of consumer goods, preferably motorcycles, motorcycle accessories, motorcycle setup configurations, and/or motorcycle accessory setup configurations, virtually modeled and virtually fitted to purchaser using at least a plurality of pairs, i.e., at least three, anthropometric measurements of the purchaser would be virtually predicted to possess acceptable comfort such as and/or preferably where purchaser has no particular preference. Such a method, apparatus and system can also be used to find which virtually modeled variation(s), customizable feature(s), user selectable option(s), user selectable/selected accessories, adjustment(s) and/or setting(s) and/or combination(s) of virtually modeled variation(s), customizable feature(s), user selected/selectable accessories, user selectable option(s), adjustment(s) and/or setting(s) of a particular consumer good, preferably motorcycle(s) selected and customized by purchaser and virtually fitted to purchaser using at least a plurality of anthropometric measurements of the purchaser would be virtually predicted to possess acceptable comfort. Such a method, apparatus and system can also be used to find which virtually modeled variation(s), customizable feature(s), user selected/selectable accessories, user selectable option(s), adjustment(s) and/or setting(s) and/or combination(s) of virtually modeled variation(s), customizable feature(s), user selectable option(s), adjustment(s) and/or setting(s) of a plurality of particular consumer goods, preferably motorcycle(s), selected and customized by purchaser and virtually fitted to purchaser using at least a plurality of anthropometric measurements of purchaser would be virtually predicted to possess acceptable ergonomics and/or comfort.

A preferred method iteratively steps through trying the virtually modeled purchaser with virtually modeled consumer good(s), preferably motorcycles, to predict which good or good(s), preferably motorcycle or motorcycles, in real life would provide minimum acceptable ergonomics and/or minimum acceptable comfort before presenting the purchaser with one or more consumer goods, e.g. motorcycle, purchasing recommendations in real life. Such a preferred method can also virtually fit the virtual purchaser to one or more virtual consumer goods, preferably one or more virtual motorcycles, one or more virtual motorcycle configurations, one or more motorcycle setups, one or more virtual motorcycle accessory configurations and/or one or more virtual motorcycle accessory setups, including by iteratively virtually fitting the virtual purchaser to a virtual consumer good, e,g. the motorcycle, motorcycle with particular configuration, motorcycle with particular setup, motorcycle with particular set of one or more accessories mounted thereto, and/or motorcycle with one or more accessories mounted and configured, where a plurality of at least one or more variation(s), customizable feature(s), user selectable option(s), adjustment(s) and/or setting(s) are iteratively varied during the virtual fitting process enabling determination of which one or more, including any one or more variation(s), customizable feature(s), user selectable option(s), adjustment(s) and/or setting(s), including combinations thereof, of the one or more such virtually modeled consumer goods would provide minimum acceptable ergonomics and/or minimum acceptable comfort before presenting the purchaser with one or more consumer goods purchasing recommendations. In one preferred method, apparatus and system, the consumer goods virtually modeled are motorcycles or bicycles with variation(s), customizable feature(s), purchaser selectable customizable option(s), adjustment(s) or setting(s) and/or combination of variation(s), customizable feature(s), purchaser selectable customizable option(s), adjustment(s) or setting(s) virtually iteratively modeled to determine which one or more would provide acceptable ergonomics and/or acceptable comfort for the purchaser based on the purchaser's anthropometric measurements. Such a method, apparatus and system can be used to find a most comfortable or optimal ergonomic consumer good or consumer goods including when customized by purchaser.

The present invention is also directed to a method, apparatus and system for enabling a purchaser to virtually try out a motorcycle (or bicycle) before actually deciding to buy with such a method enabling an anthropometric measurement based virtual model of purchaser to try on or try out the motorcycle, including any variations, customizable features, user-selectable options, adjustments and/or settings to determine whether the motorcycle, including any variation(s), customizable feature(s), user selectable option(s), adjustment(s) and/or setting(s) would provide a more optimal and preferably suitably predicted experience for purchaser that would result in a purchase recommendation being generated. A preferred apparatus is a kiosk for point of purchase or retail use that is visually configured in a manner that represents the motorcycle available for virtually try before purchase by purchaser virtually modeled to virtually use or operate the motorcycle in a virtually modeled use or operating position. A preferred system includes a database of at least a plurality of pairs of virtually modeled makes, models and/or platforms of motorcycles along with at least a plurality of pairs of virtually modeled or virtually variable variations, customizable features, user-selectable options, adjustments, and/or settings to which a virtually modeled purchaser can be mounted on, fitted to, try on, or otherwise virtually try out before purchase.

Such a method, apparatus and system can be used to find which one of at least a plurality of or a plurality of pairs of motorcycles virtually modeled and virtually fitted to purchaser using at least a plurality of anthropometric measurements of purchaser would be virtually predicted to possess acceptable ergonomics and/or comfort where purchaser has no particular preference. Such a method, apparatus and system can also be used to find which virtually modeled variation(s), customizable feature(s), user selectable option(s), adjustment(s) and/or setting(s) and/or combination(s) of virtually modeled variation(s), customizable feature(s), user selectable option(s), adjustment(s) and/or setting(s) of a particular motorcycle selected and customized by purchaser and virtually fitted to purchaser using at least a plurality of anthropometric measurements of purchaser would be virtually predicted to possess acceptable ergonomics and/or comfort. Such a method, apparatus and system can also be used to find which virtually modeled variation(s), customizable feature(s), user selectable option(s), adjustment(s) and/or setting(s) and/or combination(s) of virtually modeled variation(s), customizable feature(s), user selectable option(s), adjustment(s) and/or setting(s) of a plurality of particular makes, models and/or platforms of motorcycles selected and customized by purchaser and virtually fitted to purchaser using at least a plurality of anthropometric measurements of purchaser would be virtually predicted to possess acceptable ergonomics and/or comfort.

A preferred method iteratively steps through trying the virtually modeled purchaser with virtually modeled motorcycle(s) to predict which motorcycle or motorcycles(s) in real life would provide minimum acceptable ergonomics and/or minimum acceptable comfort before presenting the purchaser with one or more motorcycle(s) purchasing recommendations in real life. Such a preferred method can also virtually fit the virtual purchaser to one or more virtual motorcycles including by iteratively virtually posture fitting the virtual purchaser to a virtual motorcycle in a virtual riding or operating position thereon where a plurality of at least one or more variation(s), customizable feature(s), user selectable option(s), adjustment(s) and/or setting(s) are iteratively varied during the virtual posture fitting process enabling determination of which one or more, including any one or more variation(s), customizable feature(s), user selectable option(s), adjustment(s) and/or setting(s), including combinations thereof, of the one or more virtually modeled motorcycles would provide minimum acceptable ergonomics and/or minimum acceptable comfort before presenting the purchaser with one or more motorcycle purchasing recommendations. In one preferred method, apparatus and system, one or more motorcycles are virtually modeled and can include virtually modeled and/or virtually mounted variation(s), customizable feature(s), purchaser selectable customizable option(s), adjustment(s) or setting(s) and/or combination(s) of variation(s), customizable feature(s), purchaser selectable customizable option(s), adjustment(s) or setting(s) virtually iteratively modeled to determine which one or more would provide acceptable ergonomics and/or acceptable comfort for the purchaser based on the purchaser's anthropometric measurements. Such a method, apparatus and system can be used to find a most comfortable or optimal ergonomic motorcycle or motorcycles including when customized by purchaser as discussed herein.

The present invention also can be and preferably is directed to a method of evaluating one or more goods for purchase or use that includes virtually fitting a virtually modeled person using anthropometric data of the person to a virtually modeled consumer good to obtain a predictive estimate relating to ergonomics and/or comfort therefrom. In such a method, the person virtually modeled using anthropometric data of the person is fitted to the virtually modeled consumer good to obtain the predictive estimate relating to one of ergonomics and comfort. In one such method, a virtual 3-D model of the person is virtually created and virtually fitted to or on a virtual 3-D model of the consumer good to obtain the predictive estimate relating to one of ergonomics and comfort. The virtual model of the person can be and preferably is virtually fitted to or on the virtual model of the consumer good in a user or operating position where the virtual model of the person is engaged with or mounted on the virtual model of the consumer good in the user or operating position. The virtual model of the person can be and preferably is virtually fitted to or on the virtual model of the consumer good in one of a plurality of virtual user or operating positions where the virtual model of the person is engaged with or mounted on the virtual model of the consumer good in each one of the plurality of virtual user or operating positions and a determination or estimate is made relating to one of ergonomics and comfort for each one of the plurality of user or operating positions.

In a preferred method implantation, the virtual model of the person is virtually posture fitted to or on the virtual model of the consumer good in a plurality of riding positions or operating positions and a determination or estimate relating to one of ergonomics and comfort is made for each one of the plurality of riding positions or operating positions. In one such method implementation, at least one aspect, feature, component, angle, location, adjustment, or setting of the virtual model of the consumer good is changed before, during or after each virtual posture fitting of the virtual model of the person and a determination or estimate relating to one of ergonomics and comfort is made for each one of the posture fittings. In such a method implementation, at least one aspect, feature, component, angle, location, adjustment, or setting of the virtual model of the consumer good is changed before, during or after each virtual posture fitting of the virtual model of the person in at least one riding position or operation on the consumer good and a determination or estimate relating to one of ergonomics and comfort is made for each riding or operating position of each virtual posture fitting.

In a preferred method and embodiment, the consumer good that is virtually modeled is a bike or bicycle and wherein the person that is virtually modeled is a prospective or actual purchaser or owner. In one such method, one of a handlebar(s) and/or handlebar positions, angles, locations, adjustments or settings of a desired bike or bicycle is changed and each changed bike or bicycle is virtually modeled with the person virtually modeled and fitted, preferably posture fitted, to the bike or bicycle in a riding or operating position, and a determination or estimate relating to at least one of ergonomics and comfort is made for each change. In such a method implementation, at least one and preferably at least a plurality of positions, angles, locations, adjustments or settings of each handlebar virtually attached to a desired bike or bicycle are changed over a range of a plurality of positions, angles, locations, adjustments or settings for each handlebar virtually attached to a desired bike or bicycle and a determination or estimate relating to at least one of ergonomics and comfort is made for each change within the range. In a preferred implementation, one of a seat(s) and/or seat positions, angles, locations, adjustments or settings of a desired bike or bicycle is changed and each changed bike or bicycle is virtually modeled with the person virtually modeled and fitted, preferably posture fitted, to the bike or bicycle in a riding or operating position, and a determination or estimate relating to at least one of ergonomics and comfort is made for each change. In one preferred method implementation, at least one and preferably at least a plurality of the positions, angles, locations, adjustments or settings of each seat virtually attached to a desired bike or bicycle are changed over a range of a plurality of positions, angles, locations, adjustments or settings for each seat virtually attached to a desired bike or bicycle and a determination or estimate relating to at least one of ergonomics and comfort is made for each change within the range.

In one such method implementation, one of a pedal(s) and/or pedal positions, angles, locations, adjustments or settings of a desired bike or bicycle is changed and each changed bike or bicycle is virtually modeled with the person virtually modeled and fitted, preferably posture fitted, to the bike or bicycle in a riding or operating position, and a determination or estimate relating to at least one of ergonomics and comfort is made for each change. In another such implementation, at least one and preferably at least a plurality of the positions, angles, locations, adjustments or settings of each pedal or set of pedals virtually attached to a desired bike or bicycle are changed over a range of a plurality of positions, angles, locations, adjustments or settings for each pedal or set of pedals virtually attached to a desired bike or bicycle and a determination or estimate relating to at least one of ergonomics and comfort is made for each change within the range.

In one implementation, at least one of a foot rest(s) and/or foot rest positions, angles, locations, adjustments or settings of a desired bike or bicycle is changed and each changed bike or bicycle is virtually modeled with the person virtually modeled and fitted, preferably posture fitted, to the bike or bicycle in a riding or operating position, and a determination or estimate relating to at least one of ergonomics and comfort is made for each change. In one such implementation, at least one and preferably at least a plurality of the positions, angles, locations, adjustments or settings of each foot rest or set of foot rests virtually attached to a desired bike or bicycle are changed over a range of a plurality of positions, angles, locations, adjustments or settings for each foot rest or set of foot rests virtually attached to a desired bike or bicycle and a determination or estimate relating to at least one of ergonomics and comfort is made for each change within the range.

In a preferred method implementation, at least one of (a) a handlebar(s) and/or handlebar positions, angles, locations, adjustments or settings, (b) a seat(s) and/or seat positions, angles, locations, adjustments or settings, (c) a pedal(s) and/or pedal positions, angles, locations, adjustments or settings, and/or (d) a foot rest(s) and/or foot rest positions, angles, locations, adjustments or settings of a desired bike or bicycle is changed and each changed bike or bicycle is virtually modeled with the person virtually modeled and fitted, preferably posture fitted, to the bike or bicycle in a riding or operating position, and a determination or estimate relating to at least one of ergonomics and comfort is made for each change. In one such method implementation, the positions, angles, locations, adjustments or settings of each handlebar(s), seat(s) foot pedal(s) and/or foot rest(s) virtually attached to a desired bike or bicycle are changed over a range of a plurality of positions, angles, locations, adjustments or settings for each handlebar(s), seat(s) foot pedal(s) and/or foot rest(s) virtually attached to a desired bike or bicycle and a determination or estimate relating to at least one of ergonomics and comfort is made for each change within the range.

In a preferred method of the present invention, one of a combination of at least a plurality of (a) a handlebar(s) and/or handlebar positions, angles, locations, adjustments or settings, (b) a seat(s) and/or seat positions, angles, locations, adjustments or settings, (c) a pedal(s) and/or pedal positions, angles, locations, adjustments or settings, and/or (d) a foot rest(s) and/or foot rest positions, angles, locations, adjustments or settings of a desired bike or bicycle is changed and each changed bike or bicycle is virtually modeled with the person virtually modeled and fitted, preferably posture fitted, to the bike or bicycle in a riding or operating position, and a determination or estimate relating to at least one of ergonomics and comfort is made for each change. In a preferred method implementation, the positions, angles, locations, adjustments or settings of each combination of handlebar(s), seat(s) foot pedal(s) and/or foot rest(s) virtually attached to a desired bike or bicycle are changed over a range of a plurality of positions, angles, locations, adjustments or settings for each combination of handlebar(s), seat(s) foot pedal(s) and/or foot rest(s) virtually attached to a desired bike or bicycle and a determination or estimate relating to at least one of ergonomics and comfort is made for each change within the range.

In one such preferred method implementation, the consumer good that is virtually modeled is a motorbike or motorcycle and wherein the person that is virtually modeled is a prospective or actual purchaser or owner thereof. In a preferred method implementation, one of a handlebar(s) and/or handlebar positions, angles, locations, adjustments or settings of a desired motorbike or motorcycle is changed and each changed motorbike or motorcycle is virtually modeled with the person virtually modeled and fitted, preferably posture fitted, to the motorbike or motorcycle in a riding or operating position, and a determination or estimate relating to at least one of ergonomics and comfort is made for each change. In a preferred method implementation, the positions, angles, locations, adjustments or settings of each handlebar virtually attached to a desired motorbike or motorcycle are changed over a range of a plurality of positions, angles, locations, adjustments or settings for each handlebar virtually attached to a desired motorbike or motorcycle and a determination or estimate relating to at least one of ergonomics and comfort is made for each change within the range. In one such preferred method implementation, one of a seat(s) and/or seat positions, angles, locations, adjustments or settings of a desired motorbike or motorcycle is changed and each changed motorbike or motorcycle is virtually modeled with the person virtually modeled and fitted, preferably posture fitted, to the motorbike or motorcycle in a riding or operating position, and a determination or estimate relating to at least one of ergonomics and comfort is made for each change. The positions, angles, locations, adjustments or settings of each seat virtually attached to a desired motorbike or motorcycle are changed over a range of a plurality of positions, angles, locations, adjustments or settings for each seat virtually attached to a desired motorbike or motorcycle and a determination or estimate relating to at least one of ergonomics and comfort is made for each change within the range. One of a pedal(s) and/or pedal positions, angles, locations, adjustments or settings of a desired motorbike or motorcycle is changed and each changed motorbike or motorcycle is virtually modeled with the person virtually modeled and fitted, preferably posture fitted, to the motorbike or motorcycle in a riding or operating position, and a determination or estimate relating to at least one of ergonomics and comfort is made for each change. The positions, angles, locations, adjustments or settings of each foot peg or set of foot pegs virtually attached to a desired motorbike or motorcycle are changed over a range of a plurality of positions, angles, locations, adjustments or settings for each foot peg or set of foot pegs virtually attached to a desired motorbike or motorcycle and a determination or estimate relating to at least one of ergonomics and comfort is made for each change within the range. One of a foot rest(s) and/or foot rest positions, angles, locations, adjustments or settings of a desired motorbike or motorcycle is changed and each changed motorbike or motorcycle is virtually modeled with the person virtually modeled and fitted, preferably posture fitted, to the motorbike or motorcycle in a riding or operating position, and a determination or estimate relating to at least one of ergonomics and comfort is made for each change. The positions, angles, locations, adjustments or settings of each foot rest or set of foot rests virtually attached to a desired motorbike or motorcycle are changed over a range of a plurality of positions, angles, locations, adjustments or settings for each foot rest or set of foot rests virtually attached to a desired motorbike or motorcycle and a determination or estimate relating to at least one of ergonomics and comfort is made for each change within the range. One of (a) a handlebar(s) and/or handlebar positions, angles, locations, adjustments or settings, (b) a seat(s) and/or seat positions, angles, locations, adjustments or settings, (c) a foot peg(s) and/or foot peg(s) positions, angles, locations, adjustments or settings, and/or (d) a foot rest(s) and/or foot rest positions, angles, locations, adjustments or settings of a desired motorbike or motorcycle is changed and each changed motorbike or motorcycle is virtually modeled with the person virtually modeled and fitted, preferably posture fitted, to the motorbike or motorcycle in a riding or operating position, and a determination or estimate relating to at least one of ergonomics and comfort is made for each change. The positions, angles, locations, adjustments or settings of each handlebar(s), seat(s) foot peg(s) and/or foot rest(s) virtually attached to a desired motorbike or motorcycle are changed over a range of a plurality of positions, angles, locations, adjustments or settings for each handlebar(s), seat(s) foot pedal(s) and/or foot rest(s) virtually mounted or virtually attached to a desired motorbike or motorcycle and a determination or estimate relating to at least one of ergonomics and comfort is made for each change within the range. One of a combination of at least a plurality of (a) a handlebar(s) and/or handlebar positions, angles, locations, adjustments or settings, (b) a seat(s) and/or seat positions, angles, locations, adjustments or settings, (c) a foot peg(s) and/or foot peg(s) positions, angles, locations, adjustments or settings, and/or (d) a foot rest(s) and/or foot rest positions, angles, locations, adjustments or settings of a desired motorbike or motorcycle is changed and each changed motorbike or motorcycle is virtually modeled with the person virtually modeled and fitted, preferably posture fitted, to the motorbike or motorcycle in a riding or operating position, and a determination or estimate relating to at least one of ergonomics and comfort is made for each change. The positions, angles, locations, adjustments or settings of each combination of handlebar(s), seat(s) foot peg(s) and/or foot rest(s) virtually attached to a desired motorbike or motorcycle are changed over a range of a plurality of positions, angles, locations, adjustments or settings for each combination of handlebar(s), seat(s) foot peg(s) and/or foot rest(s) virtually attached to a desired motorbike or motorcycle and a determination or estimate relating to at least one of ergonomics and comfort is made for each change within the range.

In a preferred method of the present invention, a recommendation is made when a determination or estimate relating to at least one of ergonomics and comfort exceeds a predetermined value or threshold or falls within a desired range. particular consumer good or consumer good configuration is stored when a determination or estimate relating to at least one of ergonomics and comfort exceeds a predetermined value or threshold or falls within a desired range. In a preferred implementation of a method in accordance with the present invention, the method is configured in software and/or firmware and executed by a processor equipped device that includes and/or which is connected to an anthropometric data measurement device that measures one or more variables or types of anthropometric data of the person. The processor-equipped device is part of a kiosk having hardware configured in appearance and/or to appear like or relating to the consumer good. In a preferred embodiment, the kiosk has a set of handlebars and is configured with an electronic display, at least one data input device, and at least one user manipulable pointer or selection device. A kiosk further includes an audio output device or arrangement. Where equipped with an audio output device or arrangement, the kiosk has one or more speakers or audio transducers.

In a method of facilitating customization of a consumer good, the following steps are carried out: (a) providing a customizable consumer good having at least one of a plurality of user-selectable features, component choices, component locations, component arrangements, component locations, component settings, component adjustments, component angles, and/or component orientations; (b) providing an apparatus that a prospective customer interacts with that presents a plurality of user-selectable features, component choices, component locations, component arrangements, component locations, component settings, component adjustments, component angles, and/or component orientations for evaluation by the prospective customer; and (c) enabling the prospective customer to build a customizable consumer good for prospective or actual purchase by the customer using the apparatus to select from one of the plurality of user-selectable features, component choices, component locations, component arrangements, component locations, component settings, component adjustments, component angles, and/or component orientations. In a preferred aspect of the invention, the plurality of user-selectable features, component choices, component locations, component arrangements, component locations, component settings, component adjustments, component angles, and/or component orientations presented to the prospective purchaser is a subset of a larger set of at least a plurality of pairs of user-selectable features, component choices, component locations, component arrangements, component locations, component settings, component adjustments, component angles, and/or component orientations determined based on one or more characteristics of the prospective purchaser. The subset of user-selectable features, component choices, component locations, component arrangements, component locations, component settings, component adjustments, component angles, and/or component orientations is determined based on anthropometric data. In a preferred method and/or embodiment, the anthropometric data includes anthropometric data (a) of the prospective purchaser, (b) about the prospective purchaser, (c) obtained from the prospective purchaser, (d) obtained via measurement(s) of the prospective purchaser, and/or (e) obtained by scanning the prospective purchaser.

Understandably, the present invention has been described above in terms of one or more preferred embodiments and methods. It is recognized that various alternatives and modifications may be made to these embodiments and methods that are within the scope of the disclosed invention. Various alternatives are contemplated as being within the scope of the disclosed invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the disclosure shown and set forth herein.

It is claimed:

1. A method of evaluating comfort or fit of a motorcycle comprising virtually fitting a virtually modeled person using anthropometric data of the person to a virtually modeled motorcycle to obtain a predictive estimate relating to comfort therefrom.

2. The method of claim 1 comprising the step of providing a processor-equipped device in communication with a display configured to virtually model the person using anthropometric data of the person, virtually model the motorcycle using a plurality of measurements, dimensions or parameters of the motorcycle, virtually fit the virtual model of the person to the virtual model of the motorcycle, show on the display a representation of the virtually modeled person on the virtually modelled motorcycle, and show on the display the predictive estimate relating to comfort obtained from virtually fitting the virtually modeled person to the virtually modeled motorcycle.

3. The method of claim 2, wherein the processor-equipped device in communication with the display configured to (a) obtain anthropometric data of the person, (b) enable the person to select at least one of a plurality of different motorcycles, and (c) enable the person to select at least one of a plurality of motorcycle accessories to customize the selected one of the plurality of different motorcycles.

4. The method of claim 3, wherein the processor-equipped device is linked with or configured to access data containing measurements, dimensions or parameters for a plurality of different motorcycles needed to virtually model each one of the plurality of different motorcycles.

5. The method of claim 4, wherein the processor-equipped device is linked with at least one data input device or configured to access data containing measurements, dimensions or parameters for a plurality of different motorcycle accessories needed to virtually model each one of the plurality of different motorcycle accessories.

6. The method of claim 5, wherein the processor-equipped device is linked with or configured to access data containing measurements, dimensions or parameters for a plurality of different motorcycle handlebars needed to virtually model each one of the plurality of different motorcycle handlebars.

7. The method of claim 6, wherein, for each one of the different motorcycle handlebars, the processor-equipped device is configured to virtually model each one of a selected one of the plurality of different motorcycle handlebars and virtually fit the virtual model of the selected one of the plurality of different motorcycle handlebars to the virtual model of the motorcycle.

8. The method of claim 5, wherein the processor-equipped device is linked with or configured to access data containing measurements, dimensions or parameters for a plurality of different motorcycle seats needed to virtually model each one of the plurality of different motorcycle seats.

9. The method of claim 8, wherein, for each one of the different motorcycle seats, the processor-equipped device is configured to virtually model each one of a selected one of the plurality of different motorcycle seats and virtually fit the virtual model of the selected one of the plurality of different motorcycle seats to the virtual model of the motorcycle.

10. The method of claim 5, wherein the processor-equipped device is linked with or configured to access data containing measurements, dimensions or parameters for a plurality of different motorcycle foot pegs needed to virtually model each one of the plurality of different motorcycle foot pegs.

11. The method of claim 10, wherein, for each one of the different motorcycle foot pegs, the processor-equipped device is configured to virtually model each one of a selected one of the plurality of different motorcycle foot pegs and virtually fit the virtual model of the selected one of the plurality of different motorcycle foot pegs to the virtual model of the motorcycle.

12. The method of claim 5, wherein the processor-equipped device is linked with or configured to access data containing measurements, dimensions or parameters for a plurality of different motorcycle risers needed to virtually model each one of the plurality of different motorcycle risers.

13. The method of claim 12, wherein, for each one of the different motorcycle risers, the processor-equipped device is configured to virtually model each one of a selected one of the plurality of different motorcycle risers and virtually fit the virtual model of the selected one of the plurality of different motorcycle risers to the virtual model of the motorcycle.

14. The method of claim 3, wherein the processor-equipped device in communication with the display further comprises an anthropometric data gathering device configured for scanning or measuring the person to obtain anthropometric data of the person used to virtually model the person.

15. The method of claim 14, wherein the anthropometric data gathering device is configured to scan or measure the person to obtain at least one of a height, weight, inseam, arm length and waist of the person for use in virtually modeling the person.

16. The method of claim 15, wherein the anthropometric data gathering device is configured to scan or measure the person to obtain at least a plurality of the height, weight, inseam, arm length and waist of the person for use in creating a 3-D virtual model of the person.

17. The method of claim 16, wherein the processor-equipped device in communication with the display comprises a kiosk configured for retail display with the display linked to the processor-equipped device and having at least one data-input or data-entry device to enable data input by the person.

18. The method of claim 2, wherein the processor-equipped device in communication with a display comprises a kiosk configured for retail display with the processor-equipped device configured to (a) obtain anthropometric data of the person, and (b) enable the person to select at least one of a plurality of different motorcycles to virtually model.

19. The method of claim 18, wherein the processor-equipped device in communication with the display comprises has at least one data-input or data-entry device to enable input of anthropometric data of the person by the person.

20. The method of claim 1, comprising performing the following steps:
(a) virtually modeling the motorcycle using a plurality of measurements, dimensions or parameters of the motorcycle to form a virtual model of the motorcycle;
(b) virtually modeling a person evaluating comfort or fit of the motorcycle using anthropometric data of the person to form a virtual model of the person;
(c) virtually fitting the virtually modeled person to the virtually modeled motorcycle in an operating or riding position; and
(d) obtaining a predictive estimate relating to comfort based thereon that is predictive of actual comfort of the actual person mounted on the actual motorcycle in the operating or riding position.

21. The method of claim 20, wherein (i) the virtually modeled person comprises a 3-D model of the person made using anthropometric data of the person, and (ii) the virtually modeled motorcycle comprises a 3-D model of the motorcycle made using the plurality of measurements, dimensions or parameters of the motorcycle.

22. The method of claim 20, wherein the virtual model of the person is virtually fitted to or on the virtual model of the motorcycle in one of an operating or riding position on the virtually modeled motorcycle where the virtual model of the person is virtually engaged with or virtually mounted on the virtual model of the motorcycle in the one of the operating or riding position.

23. The method of claim 20, wherein the virtual model of the person is virtually fitted to or on the virtual model of the motorcycle in one of a plurality of virtual operating or riding positions where the virtual model of the person is engaged with or mounted on the virtual model of the motorcycle in each one of the plurality of virtual operating or riding positions, and a predictive estimate is made relating to one of comfort for each one of the plurality of virtual operating or riding positions.

24. The method of claim 20, wherein the virtually modeled person is virtually fitted to or on a virtually modeled seat of the virtual model of the motorcycle in one of a driver and passenger position on the virtually modeled seat of the virtual model of the motorcycle.

25. The method of claim 24, wherein the virtually modeled person is virtually fitted to or on a virtually modeled seat of the virtual model of the motorcycle in the driver position on the virtually modeled seat of the virtual model of the motorcycle.

26. The method of claim 20, wherein the virtual model of the person is virtually posture fitted to or on the virtual model of the motorcycle in a plurality of operating or riding positions, and a predictive estimate relating to comfort of the virtually modeled person is made for each one of the plurality of operating or riding positions.
determination or estimate relating to comfort is made for each one of the plurality of riding positions or operating positions.

27. The method of claim 26, wherein at least one aspect, feature, component, angle, location, adjustment, or setting of the virtual model of the motorcycle is changed before, during or after each virtual posture fitting of the virtual model of the person on the virtual model of the motorcycle, and a determination or estimate relating to comfort is made for each one of the posture fittings.

28. The method of claim 26, wherein a plurality of aspects, features, components, angles, locations, adjustments, or settings of the virtual model of the motorcycle are changed before, during or after each virtual posture fitting of the virtual model of the person in at least one riding position or operation on the motorcycle, and a determination or estimate relating to comfort is made for each riding or operating position of each virtual posture fitting.

29. The method of claim 26, comprising the further steps of
(a) virtually attaching a virtually modeled handlebar to the virtual motorcycle in an initial handlebar position, handlebar location, handlebar angle, handlebar adjustment, or handlebar setting;
(b) virtually fitting the virtually modeled person to the virtual model of the motorcycle in a riding or operating position with the virtually modeled handlebar virtually attached to the virtual motorcycle in the initial position, handlebar location, handlebar angle, handlebar adjustment, or handlebar setting;
(c) making a first determination or estimate relating to comfort for the virtually modeled person virtually fitted to the virtual model of the motorcycle in a riding or operating position with the virtually modeled handlebar virtually attached to the virtual motorcycle in the initial handlebar position, handlebar location, handlebar angle, handlebar adjustment, or handlebar setting;
(d) virtually attaching the virtually modeled handlebar to the virtual motorcycle in a second handlebar position, handlebar location, handlebar angle, handlebar adjustment, or handlebar setting disposed from the initial handlebar position, handlebar location, handlebar angle, handlebar adjustment, or handlebar setting;
(e) virtually fitting the virtually modeled person to the virtual model of the motorcycle in a riding or operating position with the virtually modeled handlebar virtually attached to the virtual motorcycle in the second handlebar position, handlebar location, handlebar angle, handlebar adjustment, or handlebar setting; and
(f) making a second determination or estimate relating to comfort for the virtually modeled person virtually fitted to the virtual model of the motorcycle in a riding or operating position with the virtually modeled handlebar virtually attached to the virtual motorcycle in the second handlebar position, handlebar location, handlebar angle, handlebar adjustment, or handlebar setting.
